(19) United States
(12) Patent Application Publication
(10) Pub. No.: US 2024/0078440 A1
(43) Pub. Date: Mar. 7, 2024

(54) METHOD FOR IDENTIFYING PATTERNS AND ANOMALIES IN THE FLOW OF EVENTS FROM A CYBER-PHYSICAL SYSTEM

(71) Applicant: AO Kaspersky Lab, Moscow (RU)

(72) Inventors: Andrey B Lavrentyev, Moscow (RU); Dmitry A Ivanov, Moscow (RU); Vyacheslav I Shkulev, Moscow (RU); Nikolay N Demidov, Mocow (RU); Maxim A Mamaev, Moscow (RU); Alexander V Travov, Moscow (RU)

(21) Appl. No.: 18/361,999

(22) Filed: Jul. 31, 2023

Related U.S. Application Data
(63) Continuation of application No. 18/361,976, filed on Jul. 31, 2023.

(30) Foreign Application Priority Data
Aug. 24, 2022 (RU) 2022122824

(51) Int. Cl. G06N 3/0985; G06N 3/063

(52) U.S. Cl. CPC G06N 3/0985; G06N 3/063

(57) ABSTRACT

Disclosed herein are methods for identifying the structure of patterns and anomalies in flow of events from the cyber-physical system or information system. In one aspect, an exemplary method comprises, using at least one connector, getting event data, generating at least one episode consisting of a sequence of events, and transferring the generated episodes to an event processor; and using the event processor, process episodes using a neurosemantic network, wherein the processing includes recognizing events and patterns previously learned by the neurosemantic network, training the neurosemantic network, identifying a structure of patterns by mapping to the patterns of neurons on a hierarchy of layers of the neurosemantic network, attributing events and patterns corresponding to neurons of the neurosemantic network to an anomaly depending on a number of activations of the corresponding neuron, and storing the state of the neurosemantic network.

### CROSS REFERENCE TO RELATED APPLICATIONS

The present application is a continuation of U.S. patent application Ser. No. 18/361,976, filed on Jul. 31, 2023, which claims priority to Russian Patent Application No. 2022122824, filed on 24 Aug. 2022, the entire contents of which are incorporated herein by reference.

### FIELD OF TECHNOLOGY

The present disclosure relates to the field of information technology and information management systems, including information and industrial security, and more specifically to systems and methods for identifying the structure of patterns and anomalies in the flow of events coming from a cyber-physical system (CPS) or an information system (IS).

### BACKGROUND

For the objects of monitoring of the CPS or IS are characterized by the presence of a flow of data characterizing the work of these objects. Such data serve as an important subject of analysis both in real time (online) and retrospectively from the collected data to detect anomalies (deviations from the normal operation of the object), as well as to identify patterns in the normal operation of the object. The latter is very important for the operator of the object, because allows you to identify cause-and-effect relationships in the operation of the object and draw conclusions about which aspect of these connections was broken, when the behavior of the object has deviated from the norm.

Data streams coming from an object of CPS or IS are divided into two groups:
telemetry of the physical processes of the CPS (sensor readings, setpoint values, levels of control actions),” hereinafter referred to as “telemetry”; and
events in the CPS (individual commands, personnel actions, alarms, etc.) and events in the IS (personnel actions, connections and similar events in the data network, the transition of subsystems to a particular state), including those accumulated with the help of solutions such as SIEM, hereinafter referred to as “events”.

For the analysis of data of the first type (telemetry of physical processes), predictive models based on neural networks and other methods of machine learning are successfully used, hereinafter referred to as predictive detectors. Examples of such detectors are described, for example, in the patents U.S. Ser. No. 11/494,252 and U.S. Ser. No. 11/175,976, which are incorporated by reference herein.

Physical processes have two properties that make predictive models possible:
Continuity: a physical process develops continuously and any of its parameters has a specific value at any given time, regardless of whether the value of the parameter is measured at that moment or not; and
Strong interdependence: the parameters of the process are rigidly interrelated in time; if all other things being equal, changes in one parameter always lead to changes in another parameter after a certain time at a certain rate (this does not mean that the laws of such changes are known; their determination that is the task of machine learning).

The second type of data is an event stream.

An event is a non-developing atomic change in the state of an object, which is characterized by the point in time when the change occurred and a set of fields (event fields) whose values describe the composition of such change.

Patterns are sequences of elements (events or other patterns) into which the flow of events from the monitored object is divided, corresponding to separate subprocesses in the operation of the object. One pattern corresponds to two sequences from the same set of elements, provided that two sequences of elements have intervals between elements within the specified limits and/or the order of the elements varies within specified limits, in particular when the composition and order of the elements are strictly observed, and the intervals between elements vary within specified limits. In the case where a pattern consists of other patterns, such a pattern is called a composite or simply a pattern, and other patterns are called nested. This hierarchical nesting of patterns is called pattern structure. Each pattern can be represented as a sequence of events through nested patterns.

Within each pattern, events or nested patterns adhere to a specific order. The intervals between them, on the one hand, are random (there is no exact repetition of time intervals), but on the other hand, they are within some framework, implicitly set by the specifics of the functioning of the object.

Patterns can be repeating (but not necessarily periodic) or new (occurred once). Repetitive patterns characterize the learned operation of an object during the monitoring time. A new event or new pattern indicates an anomaly in the operation of the object—an event or sequence of events that has not previously been observed. New patterns and, accordingly, anomalies will be considered as sequences of events with a significant change in the intervals between events while maintaining the sequence of events of a previously known repetitive pattern, or with a violation of the sequence of events (change of order, omission or appearance of new events) in comparison with previously known repetitive patterns.

Therefore, a technical problem arises, consisting in identifying in the flow of events from the CPS or IS a structure of hierarchically nested repetitive (but not necessarily periodic) patterns that reflect cause-and-effect relationships in the flow of events from the CPS or IS, as well as in attributing new patterns and new events to anomalies. That is, information about which event or pattern or what part of the pattern structure has not previously been observed indicates the presence of an anomaly in the CPS or IP.

Despite the fact that an experienced operator who is familiar with the patterns of his object is able to identify anomalies in the flow of events, the psychophysical capabilities of a person do not allow to cope with the flow of information coming from modern complex objects (dozens and hundreds of events per second). Processing of such a flow of information in real time is possible only with the help of an automated system based on machine learning and artificial intelligence (AI).

However, the event flow does not have any of the above-mentioned properties of physical processes, namely the following:

First, events are discrete: events exist only at specific points in time and are not defined in between. This circumstance does not allow the use of approaches based on modeling continuous functions, which are the basis of many machine learning methods.

Secondly, the interdependence of events is usually weak: events form repetitive sequences (for example, an event arrives “the operator of the CPS entered the machine room”, after which the event “the command was given to turn on the aggregate” is received), but the time intervals between events within the sequence can vary widely (in the example above, the normal interval between events is from 4 to 8 minutes).

Thus, for the analysis of events, technologies and predictive detectors used when working with continuous processes are not suitable due to the specific properties of events.

Known approaches in the field of detection of anomalies in sequences of events can be divided into three classes:
1) Using the principle of searching for events and sequences of events by signatures (predefined rules), see, for example, U.S. Pat. No. 9,529,690B2, US20170293757A1;
2) Machine learning-based learning on some historical sample from the event stream, see, for example, US20200143292A1; and
3) Based on the search for patterns in the flow of symbolic information, for example, using the Sequitur algorithm.

The first class of solutions can be attributed to the class of diagnostic rules (search for anomalies according to specified criteria). Solutions in this class are sensitive only to pre-known scenarios, and their use is fraught with significant difficulties in accounting for possible variations in the time intervals between events in the sequence of events.

The second class of decisions is subject to various kinds of errors associated with the initial incompleteness of the events presented in the historical sample, their order and time intervals in sequences.

The advantage of the third class is that the search is conducted over an open data stream—neither the training sample nor the set of patterns is pre-restricted. However, this class does not take into account the variability of time intervals between characters and does not implement multidimensional character streams that you have to deal with when working with events. It follows from the foregoing that the technologies known in the art do not solve the claimed technical problem. Therefore, there is a need to solve this technical problem.

Thus, there is a need for a more optimal way of identifying patterns and anomalies in a flow of events from a cyber-physical system.

### SUMMARY

Aspects of the disclosure relate to identifying patterns and anomalies in a flow of events from a cyber-physical system. In one aspect of the present disclosure repetitive events and patterns and the attribution of both new events and new patterns to anomalies in the work of the CPS or IP in the flow of events from the CPS or IS are identified. The result is achieved by machine learning methods based on a neurosemantic network without the need to divide the work process into two isolated phases from each other: (a) training on historical data and (b) inference.

In another aspect of the disclosure, the structure of patterns in the flow of events from the CPS or IS is recognized. The recognition is achieved through machine learning methods based on a neurosemantic network without the need to divide the work process into two isolated phases: a) training on historical data and b) inference.

In another aspect of the disclosure, the quality of detection of events and patterns and their attribution to an anomaly in the work of the CPS or IP is improved. The improvement is achieved due to each of the following factors: continuous online learning, additional optimization of the neurosemantic network during the special phase of the work cycle in the “sleep” mode (see e.g., FIG. 4), a mechanism for selective monitoring of the activity of a neurosemantic network based on special monitor neurons, and interaction with predictive detectors that detect anomalies in the telemetry stream.

In another aspect of the disclosure, when there are only a small number of examples of sequences of events corresponding to the pattern (one-shot learning) through the use of a neurosemantic network, the quality of detection of patterns and anomalies in the CPS or IS is improved.

In another aspect of the disclosure, the level of information noise in the flow of events is reduced, by using a mechanism that accounts for the values of event fields characterizing a particular CPS or IS.

In one exemplary aspect, a method is provided for identifying patterns and anomalies in a flow of events from a cyber-physical system, the method comprising: using at least one connector, getting event data that includes a set of field values and an event timestamp for each event, generating at least one episode consisting of a sequence of events, and transferring the generated episodes to an event processor; and using the event processor, process episodes using a neurosemantic network, wherein the processing episodes includes recognizing events and patterns previously learned by the neurosemantic network, training the neurosemantic network, identifying a structure of patterns by mapping to the patterns of neurons on a hierarchy of layers of the neurosemantic network, attributing events and patterns corresponding to neurons of the neurosemantic network to an anomaly depending on a number of activations of the corresponding neuron, and storing the state of the neurosemantic network.

In one aspect, the processing of the episode further comprises: identifying a set of events and patterns of the neurosemantic that satisfy a predetermined criterion; and generating output information about the set of events and patterns through the use of special neuron-monitor neurons of the neurosemantic network, which, by activating monitor neurons, monitor the creation and activation of the neurons corresponding to events and patterns, wherein the predetermined criteria specify at least: values of the fields of individual events and events in the patterns; a sign of an recurrence of the events and patterns; and tracking, based on a sliding time interval, the activations and the number of activations during the sliding time interval.

In one aspect, learning is partially stopped by forcing the transfer of the neurosemantic network to a mode where the creation of new neurons does not occur, and wherein all learning occurs only by changing neurons when they are activated.

In one aspect, a teacher is used for training a neurosemantic network by submitting, to the input, targeted patterns for training, and wherein a frequency of activation and/or a number of activations are based only on subsequent modification of the attribute in the generated neurons.

In one aspect, patterns are periodically removed from the neurosemantic network of unused neurons, wherein the use of neurons is determined by statistical properties of neurons and a hierarchical principle of a minimum length of description, the minimum length determining a functioning of the neurosemantic network.

In one aspect, the structure of patterns is revealed through a hierarchy of layers of the neurosemantic network, the structure determining the order of the layers of the neurosemantic network on which neurons are located, and wherein the processing of events using the neurosemantic network comprising: on the zero layer of the neurosemantic network, having neurons corresponding to the values of the event fields, grouped by channels corresponding to the event fields, wherein the duration of the terminal neuron being taken as being zero and the zero layer being a terminal layer; on the first layer of the neurosemantic network, having neurons corresponding to events, and having inputs from neurons of the terminal layer, wherein each input corresponds to the terminal neuron of the channel, different from the channels of terminal neurons of other inputs, the time intervals between event inputs from the field values being taken as being equal to zero, and a total duration of the event neuron being respectively taken as being equal to zero thereby indicating that the event has no duration; on the second layer of the neurosemantic network, having neurons corresponding to episodes, the number of inputs of the neuron of the episode being equal to the number of events in the episode, the intervals between events in the episode being exactly stored as intervals between inputs of the neuron of the episode; and the second and subsequent layers of the neurosemantic network having neurons corresponding to the sequences of events, with neurons of the third layer and subsequent layers having inputs from neurons of the previous layers and an opening of the pattern to a sequence of events being carried out through recursive disclosure of all inputs up to the first layer, and the event being expanded to the values of the fields through inputs from terminal neurons.

In one aspect, each episode is sequentially processed on the layers of the neurosemantic network: by matching the values of the event fields of the terminal neurons, by matching the events of the neurons of the first layer, by creating neurons of the top episodes on the second layer, by matching the sequences of events of the neurons of the patterns on the second and above layers up to the layer on which one neuron top neuron is mapped indicating the pattern reaching the maximum layer.

In one aspect, the activation of the pattern neuron is performed when recognizing a sequence in the event stream, with an event order corresponding an order of events obtained by opening the neuron performed recursively through inputs up to the first layer, and the duration of the detected sequence being within the interval determined by a duration of the neuron of the pattern and a neurosemantic network hyperparameter being greater that zero in accordance to d·[max(0, 1−σ), 1+σ]d, when (σ>0).

In one aspect, the neurons-monitors are created or changed by the user during the operation of the neurosemantic network on a special minus first layer, allowing to monitor the creation and activation of neurons of the neurosemantic network under specified conditions, and wherein the monitor neurons are used as output channels from the neurosemantic network to alert a user or an external system.

In one aspect, the neurons of the zero layer and subsequent layers have at least the following properties: contain a vector of input connections from the neurons of the previous layer; For the zero layer, the vector contains a single categorical or converted to a categorical value of the event field; contain a vector of time intervals between activations of connections from neurons of the previous layer fixed when the neuron was created, for the zero layer, the vector consisting of one zero value, for neurons of the first layer and subsequent layers having only one input, the duration of the single input being equal to the duration of the single input neuron; if there are output connections, the set of the output connections to the monitor neurons being minus the first layer; contain the time of the last activation of the neuron; and contain a statistical parameter that reflects the frequency of activations of the neuron, in particular the number of activations.

In one aspect, the attention configuration of the neurosemantic network is further specified by specifying attention directions for filtering the received events based on criteria for field values for recognizing patterns among events filtered in each such direction.

In one aspect, each episode is sequentially processed on layers from the second and above layers for each direction of attention in the case of setting the attention configuration, up to the layer on which a top pattern is mapped for this direction of attention or a maximum layer is reached.

In one aspect, a neuron is mapped during processing by activating a neuron of a corresponding layer if it is recognized, or by creating and activating a new neuron if a new field value, event, or pattern is observed, depending on the layer.

In one aspect, the hierarchical structure of patterns on the layers of the neurosemantic network is optimized by periodically switching the neurosemantic network to a sleep mode, wherein the events in the episodes are not processed or are processed in parallel on other computing resources, in the sleep mode, events are processed from the event history interval obtained by combining several short episodes and ordering events according to their time, for cases where some of the events in the stream came outside of their episode, and processing at long intervals for those areas of attention for which events are rare, or in the case of a change in the direction of attention.

In one aspect, the neurons have at least the following properties: contain at least one input to which a dendritic tree is attached with nodes implementing logical operations on the outputs attached to them from other neurons or from network layers; contain a dendritic node attached to the root of the dendritic tree with a logical operation “or” and outputs attached to the node from neurons of the zero and subsequent layers used to detect the activation of field values, events and patterns already learned by the network, the criterion for the subscription of the monitor neuron to the activation of such neurons being set through the definition of conditions for field values; contain 0 or more attached to the node “or” other dendritic nodes with a logical operation “and”, to which in turn are attached outputs from neurons of the zero layer corresponding to the values of the fields and outputs directly from the zero layer and subsequent layers, which are used to detect the creation of new neurons corresponding, depending on the layer, to the values of the fields, either events or patterns, dendritic nodes “and” set the conditions for what field values the neurons created on the specified layers must have in order to activate this neuron-monitor; have the ability to dynamically change the set of inputs of the monitor neuron from the network neurons to automatically add to the dendritic node “or” new created neurons that meet the criteria of the dendritic node “and”; have the ability to set an attention option on the values of the subscription fields and create child monitor neurons for each unique value or a unique combination of such values of such fields, becoming the parent monitor neuron, child monitor neurons will count the number of activations with this unique value and the rest of the subscription conditions, as in the parent monitor neuron, and notify the parent monitor about their trigger; have the ability to subscribe only to previously created and activated more than once neurons, and only to new neurons that are activated once, as well as to both together, subscribing only to new neurons being considered as anomalies in the flow of events; and contain a property for specifying the sliding monitoring interval and the amount of activation of the monitor neuron at the sliding interval, upon reaching which the monitor neuron will generate an alert to the user or other systems.

In one aspect, the sequence of events is obtained either before a fulfillment of one of the conditions, the conditions including a time limit has been reached or a limit on the number of events has been reached, or before the fulfillment of the one of the said conditions that was fulfilled first.

In one aspect, the recognizing events and patterns previously learned by the neurosemantic network includes recognizing sequences of events in which the order of events is observed, and wherein the time intervals between events are within the specified constraints stored in the form of neurons of the neurosemantic network, and wherein the activation of the neurons is recognized.

In one aspect, the training of the neurosemantic network, consists in the creation and activation of neurons that are mapped to new values of event fields, new events, and new patterns, and activation of recognized previously learned neurons in such a way that previously learned and new patterns of the neurosemantic network cover all the events of the episode.

In one aspect, the storing of the state of the neurosemantic network includes storing information about created and activated neurons in a storage subsystem.

In one aspect, an optimal coverage of all events of the episode is selected according to either a hierarchical principle of the minimum length of the description, or according to a most compact coverage of all events of current and previous episodes.

In one aspect, the processing of the episode is performed in the neurosemantic network in layers.

In one aspect, the method further comprises configuring, storing, and restoring the neurosemantic network from the storage subsystem, wherein the configuration of the neurosemantic network includes: configuration of input channels of the neurosemantic network in accordance with the event fields characteristic of a particular CPS or IP; configuration of attention of the neurosemantic network by setting directions of attention for filtering the received events based on criteria on the values of the fields for recognizing patterns among the events filtered in each such direction; configuration of permissible time deviations in the duration of the pattern, within which the neurosemantic network interprets sequences of events of the same order or nested patterns, but with different total durations of such sequences as the same pattern; configuration of hyperparameters of network layers responsible for the number of neuronal inputs on the layer; and configuration of the network hyperparameter responsible for the allowable number of layers of the neurosemantic network.

In one aspect, the method further comprises: configuring neurosemantic network activity monitors through a creation of special monitor neurons that are activated based on subscription to other neurons or layers on which new neurons are created, configure a neurosemantic network, and form a subscription according to criteria specified in terms of event field values, the sliding time interval and the number of activations of neurons to which such a subscription is to be performed; executing user requests on history of events and patterns; performing periodic optimization of the neurosemantic network in the sleep mode of the system, the optimization including optimizing the structure of patterns and recognizing patterns at long intervals of time; and performing the preservation of the state of the neurosemantic network, including information about patterns and statistics of activations on stream of events, and processed information about episodes of events.

In one aspect, a graphical user interface is used for configurations of the neurosemantic network, for controlling connectors, for the configuration of neurosemantic network activity monitors, for output of information about monitored activities and operations, for the setting of user requests for history of patterns and events, for outputting of responses to user requests, for controlling sleep mode, and for settings conditions for storing the state of the neurosemantic network.

In one aspect, the triggering of monitor neurons are stored in a storage subsystem.

In one aspect, the operation of the event processor is restarted after a shutdown while retaining previously learned events and patterns.

In one aspect, events are received from predictive detectors by CPS telemetry and/or directly from the CPS.

According to one aspect of the disclosure, a system is provided for identifying patterns and anomalies in a flow of events from a cyber-physical system, the system comprising any combination of one or more hardware processors, configured to: get event data that includes a set of field values and an event timestamp for each event, generate at least one episode consisting of a sequence of events, and transfer the generated episodes to an event processor; and process episodes using a neurosemantic network, wherein the processing episodes includes recognizing events and patterns previously learned by the neurosemantic network, training the neurosemantic network, identifying a structure of patterns by mapping to the patterns of neurons on a hierarchy of layers of the neurosemantic network, attributing events and patterns corresponding to neurons of the neurosemantic network to an anomaly depending on a number of activations of the corresponding neuron, and storing the state of the neurosemantic network.

In one exemplary aspect, a non-transitory computer-readable medium is provided storing a set of instructions thereon for identifying patterns and anomalies in a flow of events from a cyber-physical system, wherein the set of instructions comprises instructions for: using at least one connector, getting event data that includes a set of field values and an event timestamp for each event, generating at least one episode consisting of a sequence of events, and transferring the generated episodes to an event processor; and using the event processor, process episodes using a neurosemantic network, wherein the processing episodes includes recognizing events and patterns previously learned by the neurosemantic network, training the neurosemantic network, identifying a structure of patterns by mapping to the patterns of neurons on a hierarchy of layers of the neurosemantic network, attributing events and patterns corresponding to neurons of the neurosemantic network to an anomaly depending on a number of activations of the corresponding neuron, and storing the state of the neurosemantic network.

The method and system of the present disclosure are designed to identify patterns and anomalies in a flow of events from a cyber-physical system. In another aspect, the structure of patterns in the flow of events from the CPS or IS is recognized. In another aspect, the quality of detection of events and patterns and their attribution to an anomaly in the work of the CPS or IP is improved. In another aspect, the level of information noise in the flow of events is reduced.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates an example of an interaction of a system for identifying structures of patterns and anomalies in a flow of events from a Cyber-Physical System (CPS) or Information System (IS) in accordance with aspects of the present disclosure.

FIG. 2 illustrates a diagram of the components of the pattern and anomaly detection system in accordance with aspects of the present disclosure.

FIG. 3 illustrates a main cycle of an operation of the components of the pattern and anomaly detection system in accordance with aspects of the present disclosure.

FIG. 4 illustrates an operation in a “sleep” mode of components of the pattern and anomaly detection system in accordance with aspects of the present disclosure.

FIG. 5 illustrates an exemplary method for processing user requests for history of patterns and anomalies in accordance with aspects of the present disclosure.

FIG. 6 illustrates an exemplary method for processing user requests for creating a new monitor neuron during an operation of an anomaly detection system in accordance with aspects of the present disclosure.

FIG. 7 illustrates an exemplary of a basic structure of layers of a neurosemantic network for processing events in accordance with aspects of the present disclosure.

FIG. 8 illustrates main characteristics of a neuron in a neurosemantic network and application of the characteristics for event flow analysis based on episode processing in accordance with aspects of the present disclosure.

FIG. 9a illustrates an exemplary of a treatment of an episode by a neurosemantic network for a case where the direction of attention is not determined in accordance with aspects of the present disclosure.

FIG. 9b illustrates an exemplary method for processing episode for a case where one direction of attention is defined in accordance with aspects of the present disclosure.

FIG. 10 illustrates an exemplary method for processing intervals between the inputs of neurons of an episode, including cases of “transitional” neurons with one input, on layers of the neurosemantic network in accordance with aspects of the present disclosure.

FIG. 11 illustrates an exemplary implementation of a neurosemantic network activity monitoring due to special neuronal monitors on the minus first layer of this network in accordance with aspects of the present disclosure.

FIG. 12 presents an example of a general purpose computer system on which aspects of the present disclosure can be implemented.

### DETAILED DESCRIPTION

Exemplary aspects are described herein in the context of a system, method, and a computer program identifying patterns and anomalies in a flow of events from a cyber-physical system. Examples are provided for illustrating the essence of the present method for identifying the patterns and anomalies. However, the implementation is not limited to the exemplary scenarios disclosed below. The description is intended to assist a person skilled in the art for a comprehensive understanding of the disclosure.

In order to clearly describe the teachings of the present disclosure, a glossary of terminologies and concepts is first provided below.

An Information System (IS) refers to a set of computing devices and means of their communication.

A Cyber-Physical System (CPS) refers to an information technology system that integrates computing resources into physical processes. Examples of a cyber-physical system are automated process control systems, the Internet of Things (including wearable devices), and the Industrial Internet of Things.

A Technological Process (TP) refers to a physical process accompanied by a telemetry stream.

The term “telemetry” in the present disclosure refers to telemetry of physical processes of the CPS (e.g., values of process variables, setpoints, control parameters).

Process Variable (PV) refers to the current measured value of a certain part of the TP that is observed or controlled. The PV can be, for example, the measurement of a sensor.

Setpoint refers to a supported value of a process variable.

A Manipulated Variable (MV) refers to a parameter that is adjusted so that the value of the process variable is maintained at the setpoint level.

The term “object” in the present disclosure refers to an object of monitoring, such as and IS or CPS.

An event refers to a non-developing atomic change in the state of an object, which is characterized by the point in time when the change occurred and a set of fields (event fields) whose values describe the composition of the change.

“Patterns” refer to sequences of elements (events or other patterns) into which the flow of events from the monitored object is divided, corresponding to separate subprocesses in the operation of the object. One pattern corresponds to two sequences from the same set of elements, provided that two sequences of elements have intervals between elements within the specified limits and/or the order of the elements varies within specified limits, in particular, when the composition and order of the elements are strictly observed, and the intervals between elements vary within specified limits. In the case where a pattern consists of other patterns, such a pattern is called a composite or simply a pattern, and other patterns are called nested. This hierarchical nesting of patterns is called pattern structure. Each pattern can be represented as a sequence of events through nested patterns.

The patterns may be repetitive (but not necessarily periodically) or new (occurring once). Repetitive patterns characterize the learned operation of the object during the monitoring time. An event, or a new part of a pattern structure, indicates an anomaly in the operation of an object—an event or sequence of events that has not previously been observed.

To track events and patterns, the system provides a special mechanism (a technology together with a software and user interface) that allows one to notify the user or other systems about the occurrence of certain statistical and categorical conditions. For example, an alert may be issued if a pattern or event that meets certain criteria for the values of the event fields and criterion for novelty occurs on the specified sliding window for the first time, wherein the number of times exceeds a specified threshold. That is, the pattern or event occurs for the first time but the number of times exceeds the specified threshold value. The most general concept of anomaly within a given system comprises an event or pattern that is detected for the first time. If the system starts from scratch, then all events and patterns will initially occur for the first time. Therefore, before alerts are issued, it is advisable to give the system some time (depending on the monitored object) to “listen” to the flow of events and form a set of patterns and events characteristic of the operation of the (usually normal) object.

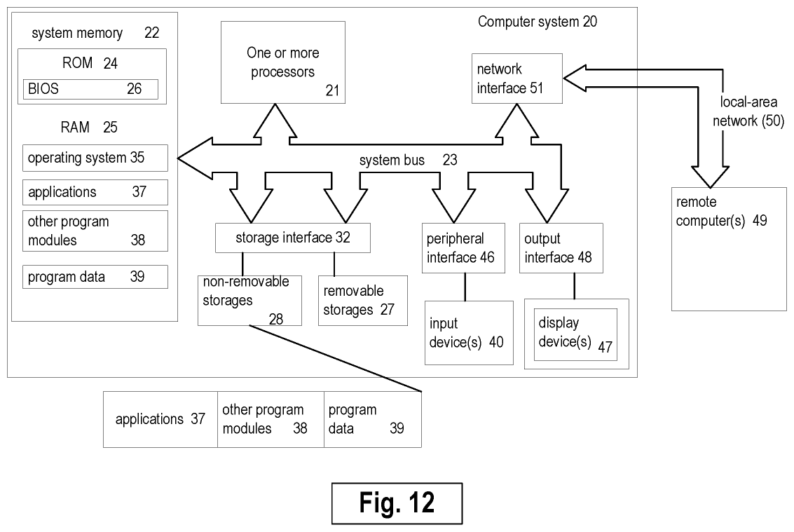

“Event processor” refers to the processor of the present disclosure and components designed to process events in the CPS or IS. The event processor may be a computer processor (e.g., processor 21 as shown in FIG. 12), functionally modified to perform a given functionality, or a software module running on a hardware processor that is configured to implement a given functionality. In a particular case, a hardware processor for an event processor may be implemented as a special neuromorphic processor comprising a plurality of elements corresponding to the neurons of a neural network or its varieties, which can process input signals in a massively parallel mode and generate output signals.

“Attention” refers to an option that indicates to the system the directions in the general stream of events, among which the event processor will search for patterns.

“Direction of attention” refers to a filter on the stream of events that selects events by field values (one or more, including the possible dynamic setting of them). For a certain direction of attention, the event processor searches for patterns only among events, each of which contains the specified values of fields. The event processor can have many directions of attention.

A “predictive detector” refers to a tool for analyzing the telemetry of physical processes, while functioning on principle of a predictive model based on neural networks and other machine learning methods.

The “diagnostic rules” are rules for analyzing the telemetry of physical processes used in cases where anomaly criteria are defined and formalized.

Security Information and Event Management (SIEM) refers to a system that provides real-time analysis of information security events emanating from network devices and applications.

In order to clearly describe identification of the patterns and anomalies in a flow of events from a cyber-physical system, the neurosemantic network is first described below.

Neurosemantic Network

In one aspect, the method of the present disclosure solves the problem of identifying (recognizing and/or creating new ones) patterns—thereby detecting anomalies in the flow of events based on the application of the neurosemantic network proposed in “Lavrentyev A. B., chapter 12 «Neurosemantic Network» in “Neuroinformatics and Semantic Representations”, Cambridge Scholars Publishing, 2020, ISBN: 1-5275-4852-X, ISBN13: 978-1-5275-4852-7”, hereinafter referred to as “Lavrentyev” and V. I. Bodyakin “Neurosemantics Information and Control Systems. Artificial Intelligence”, Scientific Works, M.: Academic Project; Mir Foundation, 2020-803 p. ISBN 978-5-8291-3825-7, ISBN 978-5-919840-39-8” hereinafter referred to as “Bodyakin”, which by its nature is closest to the spiking neural network.

Neurons of the neurosemantic network, as well as neurons of a spiking neural network, are activated by input impulses. However, the neuron of the neurosemantic network has an important difference—it is sensitive to the order and intervals between activations of its inputs. This property makes the neurosemantic network a highly effective tool for working with event flows, identifying stable sequences in them, thereby providing the user with a structure of cause-and-effect relationships of events from the object being monitored, as well as for identifying new events and new sequences of events as signs of possible deviations from the previously learned normal behavior (functioning) of the object.

The traditional, or classical, neural network used in predictive models is an approximator of a continuous function of a large number of variables. At each point in time, the output of a classical neural network is determined by the values of its input parameters.

The spiking neural network is arranged differently: the data in it propagates in the form of spikes—instantaneous excitations of neurons, and in a neurosemantic network, the order of occurrence of spikes at the inputs of the neuron and the intervals between the arrivals of spikes are of decisive importance for the generation of a neuron of its own spike. It's easy to see that spikes are intuitively similar to events.

The neurosemantic network begins the work of identifying patterns from a blank state, while the number of patterns to be detected and their length are not known in advance (not specified), but it is possible to set the directions of attention of the neurosemantic network in order to focus the identification of patterns when processing events on certain events and to avoid “noise” of patterns with those events that are less relevant.

The neurosemantic network does not have a dedicated period of preliminary training. It is constantly learning, building, and modifying its network as it receives new events from the event stream. If a newly identified sequence of events begins to repeat itself steadily, it turns from an anomaly into a pattern. Conversely, if the pattern has not been encountered for a long time, the neurosemantic network can “forget” it and then the next appearance of this sequence will already be regarded as an anomaly.

In one aspect, the representation of an event as a set of values for a certain set of fields defined for a given object is used. For example, in the private version of the CPS, the event fields may be as follows: operator name, operator terminal, installation unit, state of the installation unit. In another aspect of the IS, the event fields may be as follows: the username, the IP address of the user's terminal, the IP address of the server in the office network, the verdict issued by the server to the user's request. Event fields are in a special way set in accordance with the input channels and neurons of the neurosemantic network.

In this approach, an analogy can be indicated with the analysis of telemetry parameters from different sources, for example, the temperature, pressure and filling level of the CPS reactor can be considered as three channels (three fields) of input information.

In a particular aspect, it is possible to forcibly partially stop the learning process of the neurosemantic network by stopping the creation of new neurons in the network that correspond to new events and patterns. At the same time, part of the training is still due to the modification of previously created neurons when they are activated when recognizing patterns, events or event field values corresponding to neurons in the flow of events. This use may be appropriate in some cases, for instance, when the user knows for sure that during the training of the network the user presented all the variants of the normal behavior of the object, and the user wants to “freeze” this knowledge, thereby detecting as anomalies all new events and their sequences that did not take place in the stream of events presented during the training. In this case, the network will try to present a new sequence of events from previously occurring patterns and events, without combining them into a new pattern. If a new event occurs, the system will try to represent it in terms of the field values of previously occurred events, without creating such an event itself. However, if you encounter an event field value that has not previously occurred, the network will not activate any of its neurons, and there will be a gap in the representation of the event stream in the form of known values of event fields, events, and patterns. A user alert can also be generated for such a gap.

In one aspect, the main component of the proposed system and method for detecting the structure of patterns and anomalies in the flow of events coming from the CPS or IS may be referred to as an event processor.

In one aspect, specialized connectors (software or firmware modules) to event sources may be used to receive the event stream. In a particular aspect, for events from the SIEM subsystem, there may be a connector that supports the transmission of events and their parameters in common event format (CEF). In another particular aspect, the events may be from message brokers of other subsystems. In yet another particular aspect, the events may be from the Active Directory or Net Flow protocols. It is noted that the above particular aspects do not limit the applicability of the method of the present disclosure to other event sources.

In a particular aspect, the event processor may be used as a stand-alone detector if the object data contains only events. Such use is typical, for example, to analyze the actions of employees in order to identify erroneous or malicious operations.

Industrial facilities typically generate both types of data (process and event telemetry). In this case, the predictive anomaly detectors over the telemetry stream and the event processor complement each other. Anomalies detected by a predictive detector or diagnostic rule can be interpreted as events and sent to the event processor along with events received directly from the monitored object. Such two-level detection provides users with new opportunities to identify problem situations.

In a particular example, the two-level detection may be as follows. Suppose the performance of the compressor of the pumping station describes a continuous physical process and is controlled by a predictive detector. Then, the launch of a neighboring compressor may introduce significant distortions in the indicators and leads to the registration of an anomaly by a predictive detector. This anomaly may be fed as an event to the input of the event processor along with commands to start neighboring compressors. At the same time, there may be no strict time relationship between the command to start the neighboring compressor and the detection of the anomaly by the predictive detector on the first compressor, since the duration of this interval in a particular case is determined by a large number of factors, including those not observed by the predictive detector. Nevertheless, the event processor may detect the corresponding pattern, and in the event of a violation of this pattern, may notify the user of the anomaly: when distortions of the indicators of the first compressor occurred outside the context of starting another compressor or when the launch of a neighboring compressor did not cause a corresponding change in the behavior of the first.

Thus, the predictive detector and the event processor may solve one common problem: identifying hidden anomalies in the operation of the monitored object. However, the predictive detector and the event processor may use different types of data and, as a result, different methods of machine learning. The comparative features of these types of detectors are summarized in the table below.

| | Predictive detector | Event Processor |
|---|---|---|
| Data | Telemetry of continuous physical | Events (commands, personnel actions, |
| | processes | etc.) |
| Teaching | Prior training on a large amount of | Continuous learning in the process of |
| | historical data is required. The | analyzing the flow of events. The event |
| | detector learns internal patterns and | processor learns patterns. It is not |
| | rules that determine the course of the | necessary to formulate descriptions of |
| | process. It is not necessary to | patterns in advance. |
| | formulate the equations of the | |
| | process in advance. | |
| Anomaly | Anomalies in telemetry are | Anomalies are detected - violations of |
| Detection | revealed - deviations from the | patterns (missed or unnecessary events, |
| | normal course of the process: | incorrect order, unusual intervals |
| | unusual changes in values and | between events, new events). |
| | trends, mismatch of mutual behavior | |
| | of process variables. | |

Thus, the present disclosure describes a solution to one or more problems in the field of information management systems, including problems in information and industrial security, problem in anomaly detection (e.g., detection of anomalous events and anomalous sequences of events), concomitant problems of automatic interpretation of the structure of the regular flow of events based on the identification of patterns and their structure in the flow of events from the object of monitoring is the CPS or IS, and the like.

In order to add clarity, the composition and modes of operation are described below.

Composition and Modes of Operation

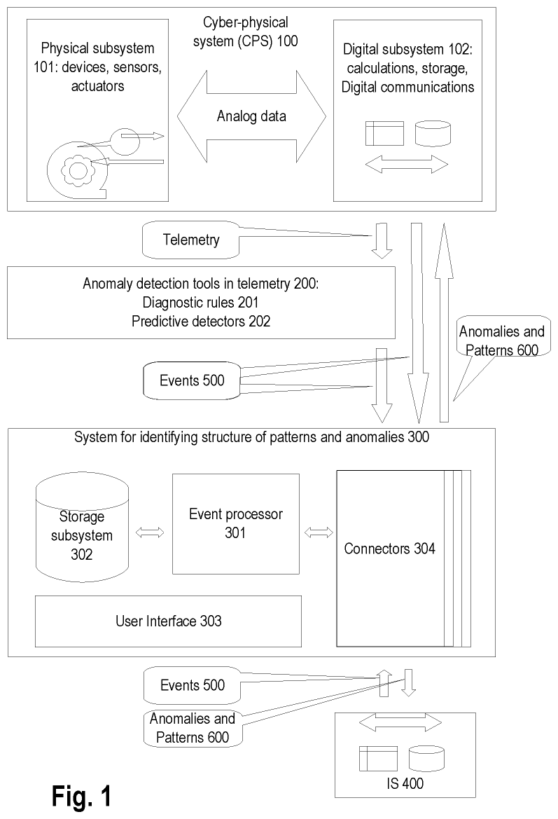

FIG. 1 illustrates an example of an interaction of a system for identifying structures of patterns and anomalies in a flow of events from a Cyber-Physical System (CPS) or Information System (IS) 300 in accordance with aspects of the present disclosure. The CPS or IS 300 may also be referred to as the pattern and anomaly detection system 300 or the system 300. The interaction of the system 300 may be with a cyber-physical system 100 (CPS 100), an anomaly detection tools in telemetry 200 (including diagnostic rules 201 and a predictive detector based on machine learning 202), and an information system 400 (IS 400). The example illustrated in FIG. 1 describes how the claimed system 300 operates. Examples of CPS 100 include, but are not limited to: process automation systems, the Internet of Things (IoTs), the Industrial Internet of Things (IIoTs), and the like.

In one aspect, the present disclosure describes a system for identifying the structure of patterns and anomalies in the flow of events coming from the cyber-physical system or information system that is implemented on a computing system, that includes real-world devices, systems, components, and groups of components realized with the use of hardware such as integrated microcircuits (application-specific integrated circuits, ASICs) or field-programmable gate arrays (FPGAs) or, for example, in the form of a combination of software and hardware such as a microprocessor system and set of program instructions, and also on neurosynaptic chips. The functionality of such means of the system may be realized solely by hardware, and also in the form of a combination, where some of the functionality of the system means is realized by software, and some by hardware. In certain aspects, some or all of the components, systems, etc., may be executed on any number of processors of a general-purpose computer (such as the ones shown in FIG. 12). Furthermore, the system components may be realized either within a single computing device or spread out among several interconnected computing devices.

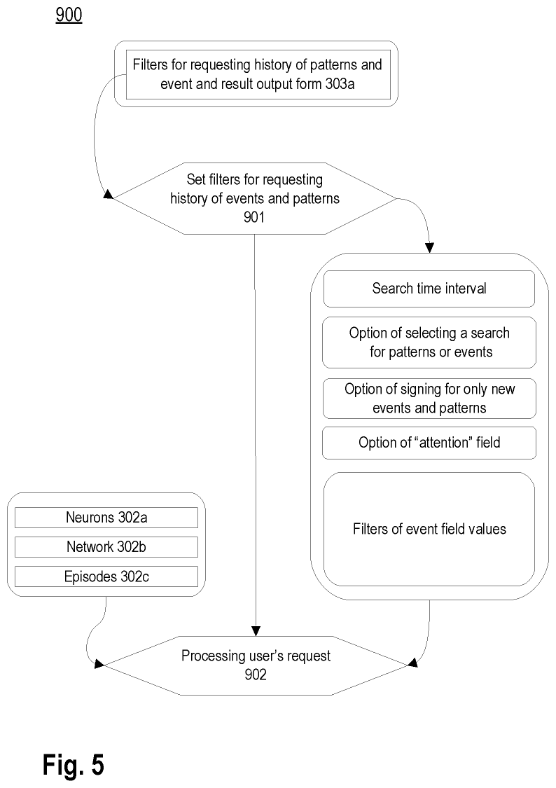

The system 300 receives events 500 directly from one or more of the following systems: CPS 100, IS 400, from anomaly detection tools in telemetry 200. Events 500 come to the connectors for receiving events and providing information about anomalies and patterns 304 (hereinafter referred to as connectors 304). Connectors 304 comprises software or software and hardware modules designed to receive events, that is, event data that includes for each event a set of field values and a timestamp of the event, as well as to provide information about anomalies and patterns. Moreover, the timestamp of the event can be both the time of formation of the event, the time of receipt of the event or another time moment characterizing the event. The connectors 304 may be implemented as services or processes running on the computer's hardware processor (see example FIG. 12). The system 300 may include a user interface 303 that allows you to monitor the activity of the neurosemantic network and query the history of events and patterns. Said history is stored in the neurosemantic network and in the storage subsystem 302 as a set of specially structured information (the structure is determined by the neurosemantic network) about events 500 and detected patterns, as well as about timestamps. Access to the history of events and patterns can be provided through the user interface 303, an example of which is presented in FIG. 5. The storage subsystem 302 may be represented by memory (e.g., a memory 22 or a special file that stores a neurosemantic network bitwise compactly, or a database with special tables for storing neurosemantic network structures, etc.) and a data processing module in this memory, made, for example, on the computer's hardware processor.

The anomaly detection tools in the telemetry 200 (hereinafter referred to as the detectors 200) receive telemetry data from the CPS 100 and transmit the identified anomalies in the telemetry as events to the system 300.

In a particular aspect, the detectors 200 are configured as a predictive detector 202 based on machine learning (described, e.g., in commonly owned U.S. Pat. Nos. 11,494,252 and 11,175,976, which are incorporated by reference herein). Information about anomalies in the telemetry of the CPS 100 additionally includes such information about the anomaly in telemetry as the time of detection (also detection or triggering) of the anomaly in telemetry, the time interval for observing the anomaly in telemetry, the main parameters of the telemetry of the CPS 100 (hereinafter referred to as the CPS parameters) that contributed to the anomaly in telemetry—the names of the CPS parameters and their values at the time of detection or at the entire interval of the anomaly in the telemetry, and information about the method of detecting the specified anomaly in the telemetry in the detector 200. In this case, the CPS parameters include the process parameters of the CPS (that is, the telemetry data of the CPS 100). The event processor 301 processes the event stream 500 using a neurosemantic network and periodically stores the state of the neurosemantic network in the storage subsystem 302.

In yet another particular aspect, the detectors 200 include a limit-based detector (the simplest kind of diagnostic rule 201) that determines an anomaly in telemetry when the value of at least one CPS parameter from a subset of CPS parameters has gone beyond a predetermined range of values for said CPS parameter. It should be noted that the predetermined ranges of values may be calculated from the characteristic values or documentation for the CPS 100 or obtained from the CPS operator via a feedback interface, such as a user interface 303.

In yet another particular aspect, the detectors 200 include a detector based on diagnostic rules 201 formed by: specifying a set of CPS parameters used in the diagnostic rule, and a method for calculating the values of the CPS auxiliary parameter, which is an indicator of the fulfillment of the criteria of this diagnostic rule. As a result, the diagnostic rules module determines an anomaly in telemetry in the CPS according to predetermined behavior criteria CPS parameters.

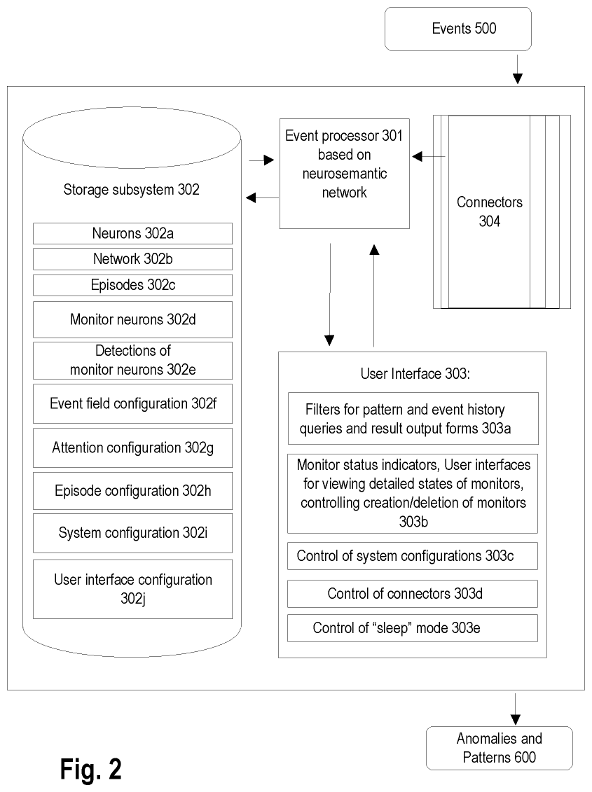

FIG. 2 illustrates a diagram of the components of the pattern and anomaly detection system 300 in accordance with aspects of the present disclosure.

In one aspect, the present system includes a key component which is an event processor that is based on the neurosemantic network 301. The general principles of operation of the neurosemantic network are described in the works of Lavrentyev and Bodyakin mentioned above. The principles of using the neurosemantic network for event processing are explained in conjunction with FIG. 2-11.

In one aspect, the events 500 are received as an event stream from one or more of the following systems: system 100, detectors 200, or system 400 to connectors 304. Event data 500 is represented as a set of field values and a timestamp. Field values may take categorical values or numeric values.

In one aspect, the event data is represented as a set of field values and a timestamp. The field values may be categorical values or numeric values. In a particular aspect, the event data is represented as a set of field values and a timestamp. The field values may be categorical values or numeric values.

In a particular aspect of connectors 304, events 500 may be represented in Common Event Format (CEF). In another particular aspect, the numerical values of the event fields 500 may be converted to categorical (symbolic) values, for example, by sampling with a given accuracy. In another aspect, special layers may be embedded in the neurosemantic network that allow the user to compare different numerical values (see examples in Lavrentyev and Bodyakin mentioned above).

In one aspect, connectors 304 are also designed to generate (accumulate) episodes—limited in time and/or limited in number of events sequence from the entire stream of events 500, consisting of at least one event 500.

In one aspect, an episode is considered accumulated (formed) when one of the following conditions is met:
1) the accumulation time has reached the threshold specified in the system configuration 302i (for example, 1 second)—in this case, the episode will include a sequence of events received during the specified accumulation time; and
2) the number of accumulated (received) events 500 has reached a threshold specified in the system configuration 302i (e.g., 4096 events 500)—in this case, the episode will include a sequence of the incoming number of events limited by a predetermined threshold.

In yet another aspect, an episode is considered to have been formed when the condition described above is met. For example, this variant of the accumulation of the episode may be advisable to use for the von Neumann system architecture and subsequent processing of input events.

In another aspect, when using massively parallel implementation of the hardware architecture, each individual event may be processed (when the episodes consist of a single event), which becomes appropriate when the capabilities of the hardware platform are sufficient to perform parallel processing of multiple events across all layers of the network.

In one aspect, the connectors 304 further transmit the generated episodes to the event processor 301.

In one aspect, the event processor 301 processes the received episodes using the neurosemantic network and converts the events 500 into information about the creation and activation of neurons or the activation of previously created neurons of the neurosemantic network. Processing an episode involves recognizing previously learned neurosemantic network events and patterns and pattern structure, where patterns are sequences and elements (events or nested patterns) in which the order of the elements is observed, and the time intervals between the elements are within the specified constraints stored as neurons of the neurosemantic network, and the activation of these neurons is observed.

In addition, episode processing involves neurosemantic network training, which includes creating and activating neurons that map to new values of event fields, and recognizing new events, as well as new patterns so that previously learned and new patterns of the neurosemantic network cover all events of the episode.

In one aspect, all events of the current (currently processed) and previous episodes are covered in the most compact way in accordance with the principle of operation of the neurosemantic network—the hierarchical principle of minimizing the length of the description.

In one aspect, episode processing also involves assigning events and patterns corresponding to neurons in the neurosemantic network to anomalies based on the number of activations of the corresponding neuron.

In one aspect, the processing of the episode further includes identifying events and patterns that meet predetermined criteria, and generating output information (alerts) about said events and patterns, through the use of special neuron-monitor neurons of the neurosemantic network that monitor (by activating monitor neurons) the cases of creation and activation of neurons corresponding to events and patterns, wherein the criteria are specified at least:
on the values of the fields of individual events and events in the patterns;
a sign of the recurrence of such events and patterns; and
on a sliding time interval to track such activations and the number of such activations over a sliding time interval.

In other aspects, it is possible to preserve the facts of detection of such events and patterns as the history of alerts that meet the specified criteria.

The event processor 301 serves to recognize the hierarchical nesting of patterns (pattern structure) through a hierarchy of layers of the neurosemantic network on which neurons are located, and on the zero (terminal) layer there are neurons of event field values grouped by channels corresponding to event fields, on the first layer there are event neurons, on the second layer there are patterns consisting of events, on the third (if any) and higher layers (if any) there are patterns consisting of patterns of the previous layer (nested patterns).

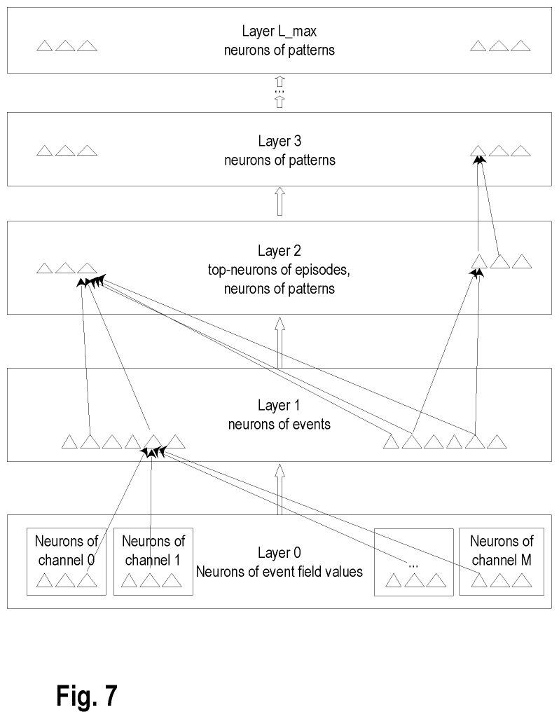

The results of the episode processing, in particular information about the creation and activation of neurons, the event processor 301 stores as part of a neurosemantic network in the storage subsystem 302 in the form of neurons 302a, a network 302b (neural connections), as well as a linear from time, but compactly presented part of the information about the composition of the episode 302c (as a single-activated neuron for each episode with exact intervals between events—see e.g., FIGS. 7-10).

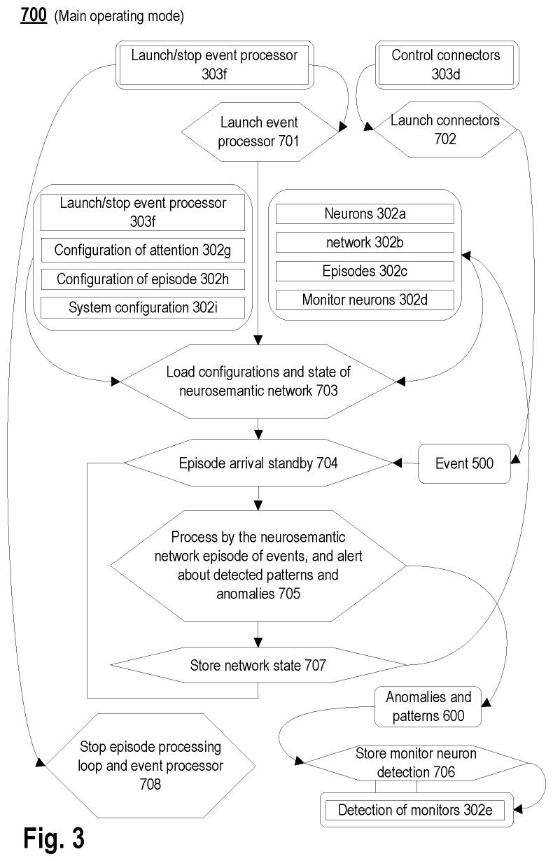

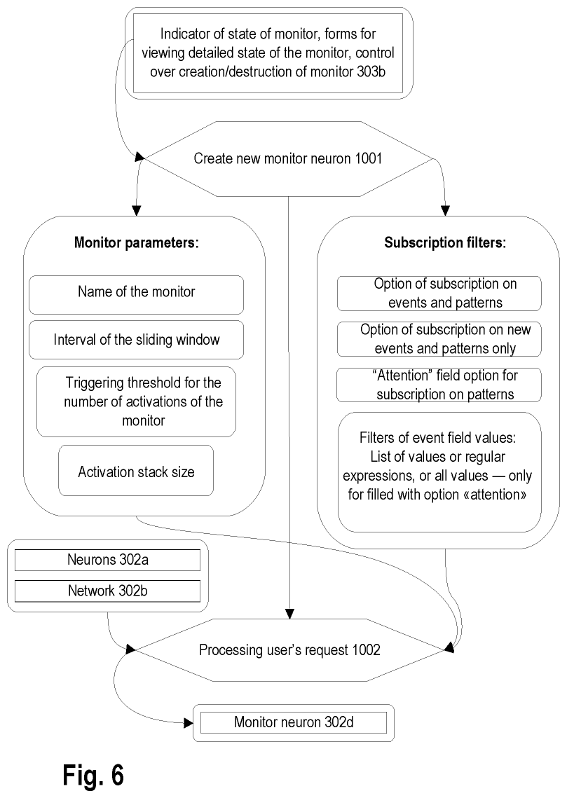

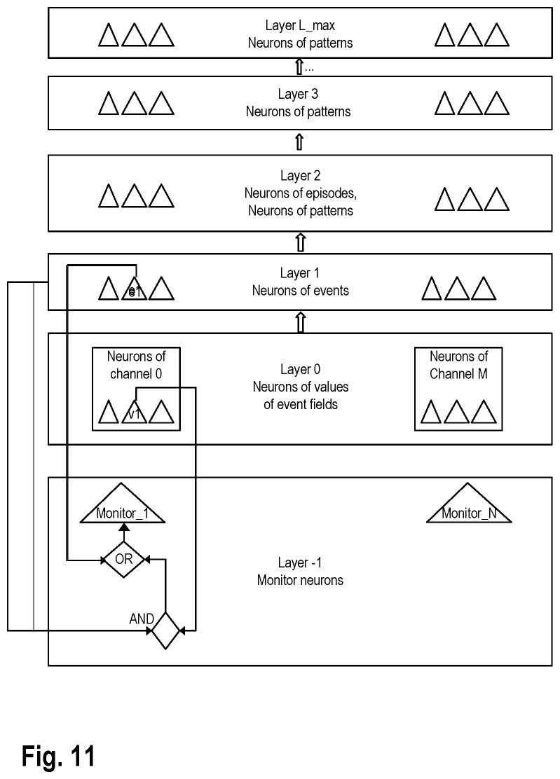

Additionally, the storage subsystem 302 stores:
information about special neurons of the neurosemantic network, designated as 302d monitor neurons (see FIGS. 6, 11 for details);
information about patterns and anomalies 600 detected by monitor neurons 302d-detections of monitor neurons 302e (see FIGS. 3, 6, 11 in more details);
event field configuration information 302f;
attention configuration information 302g (see FIGS. 6, 11 for details);
episode configuration information 302h;
information about the system configuration 302i, including information about the hyperparameters of the neurosemantic network (for example, the number of layers, the number of neuron inputs on each layer); and
information about the configuration of the user interface 302j (described in more detail below).

In one aspect, prior to the start of the system 300, a start configuration of the system 300 may be determined, comprising certain configurations 302f-302i at the time of the start of the system 300.

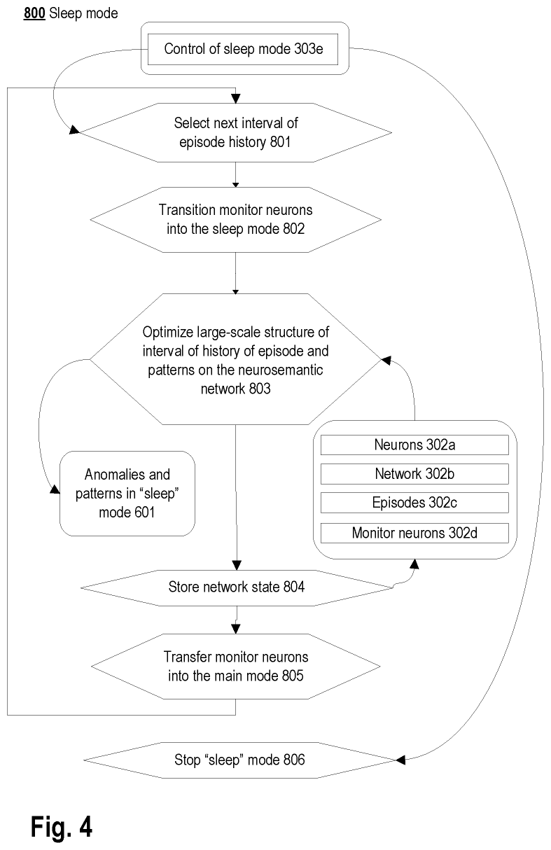

In one aspect, the system 300 may include a user interface 303 that comprises the following elements according to configuration 302j:
filters for specifying pattern and event history queries and result output forms 303a (see e.g., FIG. 5 for details);
monitor status indicators (functionality that provides the ability to monitor) based on monitor neurons 302d, user interfaces for viewing the detailed state of monitors, controlling the creation of new and deleting previously created monitors 303b (see e.g., FIG. 6);
controls of system configurations 303c (controls 302f, 302g, 302h, 302i);
connector controls 303d (see e.g., FIG. 3, action 702); and
controls for the cycle of operation of the system 300 in the “sleep” mode 303e (see more FIG. 4).

In one aspect, using the user interface 303 allows a user to monitor the activity of the neurosemantic network and make queries on the history of events and patterns.

FIG. 3 illustrates an exemplary method of a main cycle of an operating mode 700 of the pattern and anomaly detection system 300 in accordance with aspects of the present disclosure.

In step 701, method 700 launches event processor 301. In one aspect, the event processor 301 is launched in response to a user action. The user action for launching the process may be performed directly or indirectly. For example, the process may begin with the launch of the event processor 301, which can be performed by the action of the user 303f (directly or indirectly—by specifying the appropriate system configuration 302i at the time of start of the system 300).

In step 702, method 700 launches connectors 304. The receipt of events begins with the launch of the connectors 304, which, for example, can be initiated by the user (by controlling the connectors 303d—directly or indirectly through the configuration at the start of the system 300). Upon accumulation of the episode and after the event processor 301 is in standby mode (see e.g., step 704), events 500 may be transmitted to the event processor 301.

In step 703, method 700 loads configuration and state of neurosemantic network into memory from a storage subsystem, e.g., the storage subsystem 302 (for example, from random access memory 25 in FIG. 12) of the neurosemantic network. In one aspect, the loading of the configuration and state of neurosemantic network may include configurations of event fields 302f, configurations of attention 302g, configuration of the episode 302h, system configuration 302i, as well as the previous state of the neurosemantic network: neurons 302a, network 302b, episodes 302c, monitor neurons 302d. After loading the configuration and state of neurosemantic network into memory, the method proceeds to step 704.

In step 704, method 700 the event processor 301 enters an episode arrival standby mode.

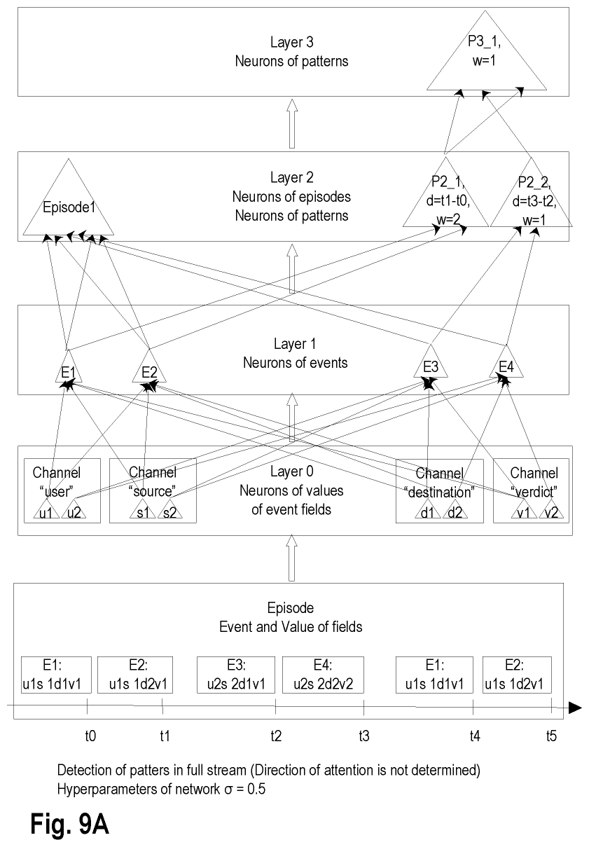

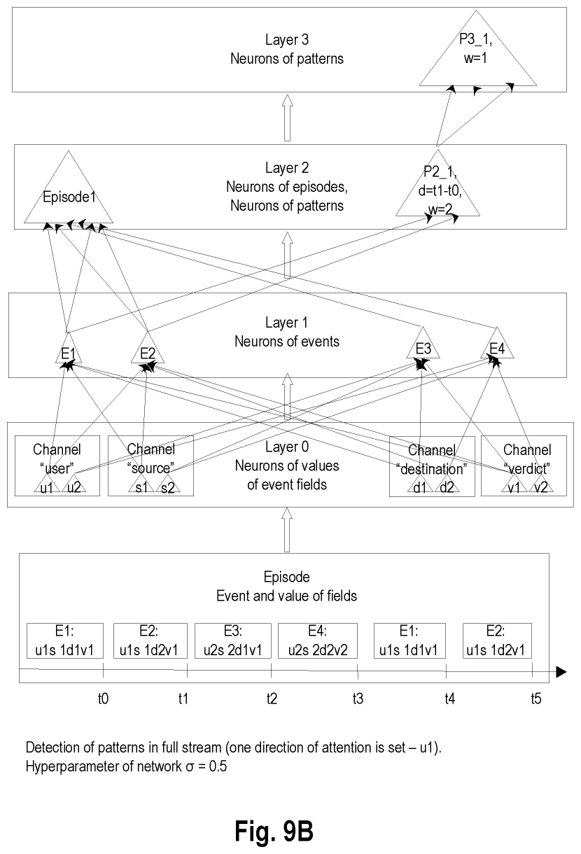

In step 705, method 700, by the neurosemantic network of the event processor 301, processes episode of events, generates alerts, by monitor neurons 302d, about detected patterns and anomalies. These processes are further described in more detail in conjunction with the descriptions of FIG. 9a-11. If the condition for the formation of alerts by the monitor neuron 302d is met during the processing of the episode (see e.g., FIGS. 6, 11), then in the user interface 303 of the monitor 303b, the method updates the corresponding trigger indicator of the monitor neuron 302d corresponding to monitor neuron 302d on the current sliding window, sends an anomaly or pattern alert 600 to external subscribers of the CPS 100 and IS 400 (for example, a remote server, other CPS or IS associated with the specified ones), and proceeds to steps 706 and 707.

In step 706, method 700 stores the monitor neuron detection. For example, store the detection of a monitor neuron 302e, in the storage subsystem 302.

In step 707, method 700 stores the state of the network. For example, upon completion of step 705, the state of the network is stored in step 707. The state of the network may include updated information about neurons 302a, network 302b, episodes 302c, and monitor neurons 302d in the storage subsystem 302. Method 700 returns to step 704 to repeat steps 704, 705 and 707 until the event processing is terminated, for example, in response to a user request. For example, a loop consisting of steps 704, 705, 707 is repeated until the event processor 301 stops at step 708.

In one aspect, method 700 receives a loop stop call from a user through the user interface 303. In another aspect, a call to stop the main loop may be made by the system 300 in accordance with the “sleep” mode configuration specified in the system configuration 302i. In another aspect, the main loop may be stopped when the entire system 300 is stopped.

In one aspect, the storage subsystem 302 further serves to provide the ability to restart the operation of the event processor after a shutdown while storing previously learned events and patterns.

In one aspect of the storage subsystem 302, it is possible to store the state of the neurosemantic network in a special bit-coded file that reflects the basic principle of operation of the neurosemantic network—the minimum length of the description (see Lavrentyev mentioned above).

FIG. 4 illustrates an example of operation of the system 300 in a “sleep” mode 800 of components of the pattern and anomaly detection system in accordance with aspects of the present disclosure. The “sleep” mode allows users to optimize the large-scale structure of the neurosemantic network and identify patterns and anomalies 600 at large intervals, which can be difficult in real-time event processing mode. Such optimization requires additional ordering of events. In one particular aspect, this may be a repeated summary treatment of previously processed short episodes. In another particular aspect, this may be the processing of episodes for which late events were subsequently received that came in other episodes, but with timestamps that are within the time limits of events from previously processed episodes. In the third particular variant, due to a change in the direction of attention, it may be necessary to re-process part of the history of the episodes in order to search for patterns with new directions of attention. These options are presented as an example and do not limit the possibility of using the “sleep” mode to optimize the large-scale structure of the neurosemantic network.

The sleep mode 800 operates in a loop (the terms “loop” and “cycle” are used interchangeably herein). In a particular aspect, the episode history interval specified as part of the configuration of the system 300 is processed in one cycle. For example, if the episode size is set as 4096 events or 4 seconds of waiting, the interval of one cycle of the “sleep” mode can be equal to 100 episodes and cover the story interval of 400 seconds of time clock by the data source.

Another set of parameters in the system configuration 302i of the system 300 are parameters that determine when and for how long the system 300 can go into “sleep mode”. In one particular aspect, this may be the time of day when the flow of events is least intense (for example, in the period 01:00-06:00), and for the duration of the loop in sleep mode, it is possible to suspend the main mode 700 of processing real-time events. In this case, events 500 can be temporarily accumulated in the connectors 304 for the purpose of their subsequent processing after exiting the “sleep” mode. In another particular aspect, when the computing resources of the system 300 there is enough to process the stream of events in real time, part of the resources can be transferred to the parallel execution of cycles in the “sleep” mode.

In step 801, method 800 selects a next interval of episode history. Thus, the sleep mode cycle 800 begins by selecting the next interval of episode history.

In one aspect, the system 300 may remember the end of the previous interval of the cycle in sleep mode and start a new cycle in sleep mode with the subsequent interval. In another aspect, the system 300 may retain signs of those episodes that, for various reasons (for example, at the request of the user), should be optimized. In one aspect, an indication of the need to optimize an episode is too few events in an episode received in real time. In another aspect, an indication of the need to optimize an episode may be a change in the direction of attention of the user. In another aspect, an indication of the need to optimize an episode is a small number of events in the episode in one or more areas of attention.

In step 802, method 800 makes transition of monitor neurons, e.g., monitor neuron 302d, into sleep mode. The monitor neurons are configured to distinguish between the data sources on which patterns and anomalies are detected. If a pattern or anomaly is detected at a history interval reprocessed in sleep mode, the alert is not generated or is generated only for exceptional cases, for example, associated with patterns identified at long intervals of time or in new areas of attention. If the patterns are highlighted in the real-time mode (the main method 700 for processing events) in parallel with the method 800 of the “sleep” mode, then the alert is performed.

In step 803, method 800 optimizes large-scale structure of the interval of the history of episodes and patterns of the neurosemantic network. For example, the events 500 received at this interval are reprocessed, combining them into longer, optimal episodes for this object and neurosemantic network. For instance, episodes of 4 seconds that received 100 events are combined into long episodes of 4096 events or, if the total number of events in the interval is less, the number of events available at the interval is combined. Note that the optimality of the number of 4096 elements in the episode of the neurosemantic network is explained in the work of of Lavrentyev mentioned above. Also, at the interval, patterns are reprocessed. The reprocessing takes into account the current configuration of attention 302g. In the process of restructuring patterns, the neurosemantic network can detect more optimal patterns, as well as patterns covering longer periods of time. Pattern optimality is a key characteristic of the neurosemantic network (see more in Lavrentyev and in FIG. 7) and is determined by the attributes of the neuron corresponding to the pattern, and primarily by the following attributes: the number of activations (w), the number of nested patterns or events (k) that make up the pattern and the number of their activations (wp), the number of field values of all events of the pattern (l) (see more in the work of Lavrentyev mentioned above).

In step 804, method 800 stores the state of the neurosemantic network. The state of the neurosemantic network is stored after optimizing the history interval (neurons 302a, network 302b, episodes 302c, monitor neurons 302d while taking into account their sleep mode).

In step 805, method 800 transitions the monitor neurons to the main mode. For example, the monitor neurons 302d returns to the main mode. The method then proceeds to step 801 to repeat the sleep cycle.

In step 806, when a control message for stopping the sleep cycle is selected, method 800 stops the cycle and exits the “sleep” mode. In one aspect, the control for stopping the sleep cycle occurs according to the selected control of the “sleep” mode 303e.

Note that at steps 705 (episode processing) and 803 (optimization of large-scale interval structure), an operation can additionally be performed to periodically delete rarely used neurons of the neurosemantic network (not displayed in FIGS. 3 and 4) corresponding to some patterns that were created on some layer, but were not used in covering the episode (coding) on this layer of the neurosemantic network, because the neurosemantic network has identified other patterns that better cover the observed sequences of events (for example, those that are more common in the flow of events and are therefore advantageous for minimizing the length of the description of the entire information flow, i.e. to fulfill the basic principle of encoding information in a neurosemantic network (see Lavrentyev mentioned above). This operation allows user to optimize the volume of neurons in the network and, accordingly, significantly reduce the resource requirements of the storage subsystem 302, without losing a significant part of the statistical information on events and patterns in history.

FIG. 5 illustrates an exemplary method 900 for processing user requests for history of patterns and anomalies for system 300 in accordance with aspects of the present disclosure.

The user interface 303 of the system 300 provides filters for requesting history of patterns and events, as well as result output forms 303a.

A user of the system 300 (e.g., a CPS or IS operator) may set filters for requesting history of events and patterns at step 901. To do this, the user:
specifies the search time interval;
specifies whether he searches for individual events or patterns;
specifies whether he is interested only in new events or patterns or those that have been activated several times;
when querying for the history of patterns, specifies the “attention” option for at least one field from the composition of those fields that are specified in the configuration of the directions of attention 302g; when querying for the history of events, the “attention” option is not indicated; and
defines the desired filters of values of fields of individual events or events occurring in patterns; the filter can be specified by a list of desired values or by a regular expression; additionally, the “all values” filter option may be selected for the field with the “attention” option when searching for patterns—in this case, the values that are defined in the attention configuration 302g for this field for the system 300 will be used.

In step 901, method 900 sets filters for requesting history of events and patterns.

In step 902, by the system 300, method 900 processes the user request using the stored states of neurons 302a, network 302b, episodes 302c, and gives the user a result containing the found events and patterns, with the ability to indicate the corresponding numbers of neurons, numbers of their activations, and dates of the last activation. In the case of patterns of layers 3 and above, the neurosemantic network (see FIG. 7-10) for the pattern indicate its constituent nested patterns of the previous layer, which in turn can be recursively expanded to the events that make them up and the values of the fields of these events. In one particular aspect, the results of step 902 may be presented in table view; the table view of the user specifies the configuration of the user interface 302j.

In another particular aspect, the result of the event search may be represented as a directed acyclic graph, for which the user specifies the configuration of the event fields 302f, in which he indicates the semantic relationships of the fields: which event fields are considered the beginning of the graph, which are internal vertices, and which are the final vertices of the graph. For example, for a particular version of the fields: “user”, “computer” of the user, “system” to which the user refers, and the “verdict” received for this appeal—the nodes of the relationship graph can be built on the principle: 1) which “user”, 2) from which “computer”, 3) which “system” turned to and 4) which received the “verdict”. Possible results views are not limited to the examples above.

FIG. 6 illustrates an exemplary method 1000 for processing user requests for creating a new monitor neuron 302d during an operation of an anomaly detection system 300 in accordance with aspects of the present disclosure.

The user fills out the form 303b of the user interface 303 to create a new monitor, while the monitor is stored in the system 300 as a monitor neuron 302d. To do this, the user fills in the following monitor parameters:
the name of the monitor that the user can understand.
sliding window interval the monitor neuron 302d on a given sliding window counts the number of its activations;
triggering threshold for the number of activations of the monitor neuron 302d on the sliding window—when this threshold is exceeded, the monitor neuron 302d generates and sends an alert about the detected patterns or anomalies of the self, which the system 300 delivers to the external systems of the CPS 100 and the IS 400, and also stores it in the storage subsystem 302 in the form of a detection of a monitor neuron 302e; and
activation stack size the stack capacity in which the monitor neuron 302d will temporarily store information about recent events or patterns that activated the monitor neuron 302d, and the time of activation.

The user may also set subscription filters that define the conditions under which the monitor neuron will be activated:
determines whether the monitor neuron 302d will be subscribed to individual events or patterns;
determines whether the subscription will only be to new events or patterns, or to events or patterns that have happened before;
defines fields with the “attention” option: a) for subscribing to patterns, at least one field with the “attention” option must be specified if attention directions are specified in the configuration of the system 300, b) for subscribing to events, the “attention” option may be specified for one or more fields, forming an arbitrary temporary attention configuration for the subscription of the monitor neuron 302d on events (patterns on the temporary configuration of attention are not built). For each new combination of the values of such fields, which determines a separate direction of attention, the monitor neuron 302d creates a child monitor neuron 302d, which will count activations for events only for this particular direction. Activations of child monitor neurons 302d transmitted by the neurosemantic network to the parent monitor neuron 302d. For the convenience of the user, the child monitor neurons 302d may be hidden from the user, and the user will learn about their activations through the parent monitor neuron 302d. This mechanism allows you to organize the monitoring of events for many values of fields that may be unknown in advance, while not cluttering the user interface 303. For example, in one particular version of the configuration of the event fields of the monitored object, containing the fields: “user name”, “user host”, “user request server”, “server verdict on user request”- and when setting the “attention” option for the “user name” field for the event monitor, the monitor neuron 302d will be able to track events for each individual user (keep a separate count of the number of activations for each user), while users may be unknown in advance, because new users may appear on the monitoring object; and
defines the desired filters on the field values of individual events or events encountered in patterns. A filter can be specified by a list of desired values or by a regular expression. Additionally, for the field with the “attention” option when searching for patterns, the “all values” filter option can be selected—in this case, the field values that are defined in the attention configuration 302g for this field for the system 300 will be used.

In step 1001, method 1000 creates a new monitor.

In step 1002, by the event processor 301, method 1000 processes the user's request to create a monitor neuron based on information about the neurons 302a and the network 302b, and a special monitor neuron 302d is created. When the system 300 is operating in the main cycle or in the “sleep” cycle, the neurosemantic network of the event processor 301 activates the monitor neuron 302d according to his subscriptions (see example in FIG. 11).

In order to add clarity, the application of the neurosemantic network for event processing is described below in conjunction with FIG. 7.

Neurosemantic Network Appliance for Event Processing

In one example aspect, the neurosemantic network may be multilayered. The numbering of the main layers of the network begins with 0 and ends with L_max, where L_max is specified as the hyperparameter of the neurosemantic network. Event processing is performed precisely on the main layers of the network. There is also a layer −1 (minus one) on which special monitor neurons 302d are located (not displayed in FIG. 7, see more FIG. 11). It should be noted that this numbering is introduced for certainty of presentation and corresponds to the numbering adopted in Lavrentyev. Without losing the generality of the claims, the layer numbers can be assigned in another way, in as long as only the sequence of layer connections.

The neurons on each layer 1 through L_max have inputs only from the neurons in the previous layer. The inputs of the neurons in layer 0 and layer −1 are formed differently, see below.

Layer 0 is called terminal layer. On it are terminal neurons, which are activated by the values of event fields. Terminal neurons activated by different values of the same event field are grouped on the terminal layer by channels, i.e., the channel of the neurosemantic network is put in correspondence to the field of events. Thus, the neurosemantic network has as many input channels as the fields defined in the event. In a particular use case of a neurosemantic network, each terminal neuron has only one input that corresponds to one value of the field to which this neuron is activated.

The monitor neurons 302d of the −1 layer, unlike the neurons in the other layers of the neurosemantic network, have inputs that can connect these neurons to the outputs of neurons of any layer, as well as to the outputs of the layers of the neurosemantic network. The inputs of the 302d monitor neurons that connect them to the outputs from the layers of the neurosemantic network allow the monitor neurons 302d to subscribe to the creation of new neurons on these layers (see e.g., FIG. 11).

The channels and terminal neurons of these channels serve as inputs to the neurosemantic network. Monitor neurons 302d serve as outputs from the neurosemantic network.

Layer 1 contains neurons that correspond to events. Event neurons have inputs in numbers no greater than the number of channels (event fields). Each event neuron input is associated with a single terminal neuron, with all event neuron inputs associated with terminal neurons from different channels.

Layer 2 contains neurons that have events as inputs: these are neurons of episodes of the history of events (or neurons of episodes) and patterns (or neurons of patterns).

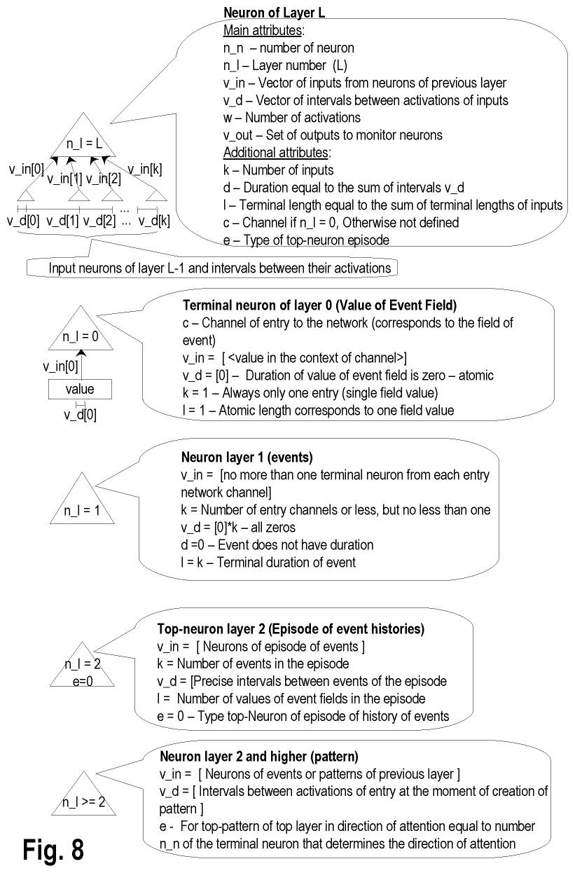

The neuron of the episode is created by the neurosemantic network when the next episode is fed to its input and its subsequent processing. The episode neuron has a number of inputs equal to the number of events in the episode. The inputs of the episode neuron allow you to restore the exact history of events, because when the neurosemantic network creates an episode neuron in its composition, the exact intervals between the arrival of events that make up the episode are preserved (see e.g., FIG. 8).

Pattern neurons correspond to sequences of events. In one aspect, in the second layer, the pattern neurons have inputs from the corresponding event neurons on the first layer. In one aspect, on layer 3 and above, there are also neurons of patterns, but they have as inputs neurons of patterns of the previous layer. Thus, in order to obtain a sequence of events corresponding to the pattern of layer 3 and above, it is necessary to recursively “expand” each input of such a neuron up to the inputs from layer 1 (the event layer).

In a particular aspect of the neurosemantic network, the pattern neurons retain the exact sequence of inputs from the neurons of the previous layer (the neuron is sensitive to the order of inputs). However, the intervals between neuron inputs allow variations: for example, if, when creating a neuron, the total duration of the intervals between activations of its inputs (hereinafter referred to as the duration of the neuron) was equal to d, then such a neuron can correspond to the same sequence of events or patterns, but with a total duration within a given interval, for example, equal d·[max(0, 1−σ), 1+σ], which depends on the duration of the neuron pattern d, and the network hyperparameter σ>0.

In another particular aspect of the neurosemantic network, the allowable interval of variation in sequence duration (to match the neuron of the duration pattern d) may be determined by a metric of the neuron's proximity to the observed sequence, e.g., based on the Gaussian distribution of the duration of the pattern ˜e

$$∼ {e}^{- {d}^{2} / {σ}^{2}} .$$

In another particular implementation, the proximity metric of the order of inputs can also be determined (see the works of Lavrentyev and Bodyakin mentioned above). In the layers of the neurosemantic network, when processing episodes by the event processor 301, new neurons are created and then activated if event field values, events, and sequences of events that have not previously occurred occur in the episode. Otherwise, activation of previously created neurons occurs (taking into account allowable variations in intervals).

The choice of certain sequences for the formation of patterns is determined by the hierarchical principle of the hierarchical Minimal Discrepancy Length, see the work of Lavrentyev and Bodyakin, mentioned above, and in a particular version of the implementation of such a principle—on the basis of the functional of the “force” of the neuron, see the work of of Lavrentyev.

For example, a pattern that corresponds to a neuron on the second layer can be created from neurons on the first layer that correspond to episode events. To do this, a sliding window is passed, for example, from 2 to 8 events (network hyperparameters), from the sequence of events of the episode and for each window that occurs for the first time, a new pattern neuron is created on the second layer. Then all the neurons, those corresponding to such windows (newly created or previously created in previous episodes) are sorted according to their statistical properties (frequency of occurrence on the entire stream, length in terms of event fields and other criteria—see the “force” functionality in the work of Lavrentyev mentioned above). Sorted neurons are used to fully cover the sequence of events of the episode, starting with the “strongest” neurons at the beginning of the list. Those neurons that are not used in such coverage are considered less optimal than those used, and can be removed to save network resources in whole or in part (in the latter case, some of the unused of the composition the neurons sorted as described above are stored and activated when they are detected in the flow of events in the expectation that in another episode, they may be more optimal). The patterns of subsequent layers of the neurosemantic network are formed in a similar way, but the input sequence for them will not be events, but patterns of the previous network layer for the current episode.

At the first start of the event processor 301, the neurosemantic network has only three layers without neurons: 0, 1, 2. When events arrive at the input of the neurosemantic network and their layer-by-layer processing, new neurons and layers from 3 to L_max are added to the network—as the corresponding neuron patterns appear, as well as layer −1—when the user adds monitor neurons.

FIG. 8 illustrates main characteristics of a neuron in a neurosemantic network and application of the characteristics for event flow analysis based on episode processing in accordance with aspects of the present disclosure. Thus, FIG. 8 shows the neurons of the neurosemantic network and their correspondence to field values, events, episode histories, and patterns.

The general attributes of a neuron in a neurosemantic network are shown in the example of a neuron in layer L. A neuron is identified by the number of the neuron and the number of the layer. The main attributes comprise:
n_n is the number of the neuron;
n_l is the layer number (for layer L, n_l=L);
v_in is the vector of inputs from the neurons of the previous layer;
v_d is a vector of intervals between activations of inputs (what these intervals were when this neuron was created);
w is the number of activations of the neuron; and
v_out—a set of outputs to monitor neurons.

In addition, there are a number of other important attributes such as:
k is the number of inputs that is limited by the hyperparameters of the upper and lower limits of the number of neuronal inputs on each layer of the neurosemantic network specified as part of the system configuration 302i, by default, for example, the interval [2, 8];
d is the duration equal to the sum of the intervals v_d;
l is the terminal length equal to the sum of the terminal lengths of the inputs;
c is the channel if n_l=0, otherwise not defined; and
e is the type of top neuron, if it is an episode or a top pattern, otherwise not defined.

The definitions of the episode top neuron and the top pattern are presented below. In addition, explanations of the above attributes are provided below.

On the layers of the neurosemantic network, when processing sequences of events that come in the form of episodes, the neurosemantic network creates and activates new neurons or activates existing neurons. All events of the episode (neurons of layer 1) are combined by the neurosemantic network into one top neuron of the episode on the second layer of the network.

In addition, if the directions of attention are defined (see e.g., FIG. 9b), then the identification of patterns occurs from the sequences of events obtained from the full sequence of events of the episode by filtering only events containing field values corresponding to their direction of attention. For each such filtered sequence of events on some layer of the neurosemantic network, all the identified patterns are combined into top-pattern (or in several top-patterns for the case when the maximum possible layer of the network is reached, but the coding did not reduce the episode to only one top neuron; the latter is characteristic of the event stream containing long repetitive sequences, which, when encoded, lead to repeating patterns on each layer of the network, which it is advisable to leave without combining them into even more long patterns).

For top neurons (top neurons of episodes and top patterns), a special attribute e is defined. For the top pattern, this attribute determines the correspondence to the direction of attention. For the top neuron of the episode, this attribute has the value of 0. For neurons that are not top neurons, attribute e is not defined. It should be noted that the choice of specific values of this attribute may be different, only the principle of correlating the top-neuron with the top-neuron of the episode or with the top-pattern in the direction of attention is important.

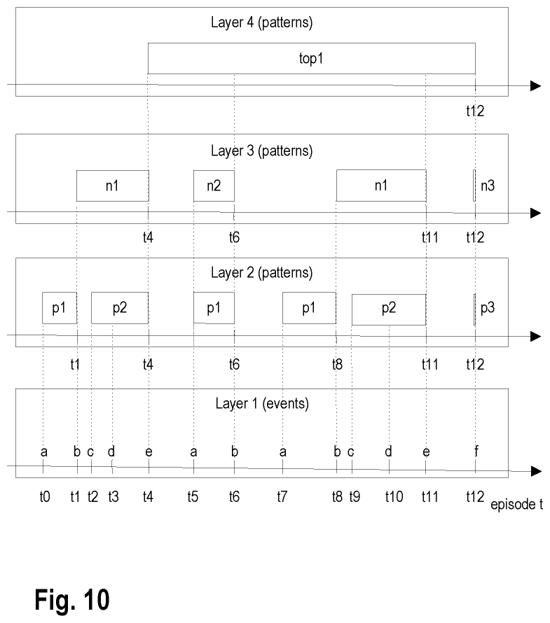

The first interval v_d[0] in the v_d vector of the neuron is usually zero. If it is a neuron of layer 0 that corresponds to the value of the event field, then it has one input of zero duration, because the value of the event field has no duration. If it is event, then the inputs correspond to the values of the fields and the intervals between them according to the definition of the event adopted in the present disclosure are zero. If it is an episode neuron event history or neuron pattern, then the neuron itself contains information only about the intervals between activations of its inputs, and information about what happened before the activation of the first input for such a neuron is not contained in the neuron itself. However, for the latter statement there is an exception associated with the possibility of the existence of “transitional” neurons-patterns, which have only one input. The semantic meaning of the “transitional” neurons is explained in the work of Lavrentyev mentioned above. These neurons “transmit” the pattern of the previous layer to the current layer. At the same time, the duration of the transmitted pattern of the previous layer is known and it determines the first interval v_d[0] of the only input of the “transitional” neuron. This feature is explained in conjunction with FIG. 10. This approach allows the user to save all the time intervals between the events of the episode when sequentially mapping (encoding) the neurons of the patterns on the layers of the neurosemantic network.

The rule that the first interval is zero should be taken into account when understanding the meaning of the duration d of the neuron of the pattern. For neurons of layer 3 and above, in general, d is not equal to the duration of the sequence of events corresponding to this neuron and obtained by opening the neuron to layer 1, because the first input will also be a pattern that has its own duration, and the duration of the first nested pattern is not taken into account in the duration d. A neuron “knows” the intervals only between activations of its inputs, but “does not know” what happened before the activation of its first input (the neuron of the first nested pattern “knows” about this).

It should be noted that for patterns identified in a given direction of attention (see e.g., FIG. 9B), on layer 1, only those events that correspond to the direction of attention are selected by the network from the full sequence of events of the episode. Accordingly, the intervals are counted between the selected events.

The above is formalized as follows:
if (L=0) or (L=1) or (L>1 and k>1), then the interval v_d[0]=0; and
if (L>1), and e does not point to the top neuron of the episode (i.e., it is a neuron of a pattern or top-pattern), and (k=1), then the interval v_d[0] is equal to the duration of the neuron of the layer (L−1).

The upper bound of the number of inputs of a neuron k is the hyperparameter of the neurosemantic network layer. The greater the k, the faster the sequence of events will be encoded into one top pattern of some layer. For a smaller upper bound k, more layers of the neurosemantic network will be required for such coding. The minimum encoding speed corresponds to the lower bound k=2. In addition, it is noted above that there may be “transitional” neurons with k=1. In a particular application of the principle of learning a neurosemantic network due to the hierarchical minimization of the length of the description in Lavrentyev. If, during the processing of the episode on some layer it turned out that all the neurons-patterns have just been created, i.e., activated only once on a given episode, and therefore all w=1, then the network “folds” them into one top-pattern of the episode on the next layer, and the number of inputs from such a top-pattern can exceed k (see more work in Lavrentyev). Similarly, the top neuron corresponding to the episode can have a value of the k attribute above the boundary specified for layer 2.

The l attribute is the terminal length of the neuron, which in the proposed approach corresponds to the number of field values in the entire sequence of events corresponding to the neuron. It should be noted that some events may not have all the values from the full set of fields, respectively, the terminal length of such events will be less than that of events with a full set of fields.

The v_out attribute is used by the neurosemantic network to alert monitor neurons (see v_out in FIG. 11) on the minus first layer (−1) of networks subscribed to the activation of this neuron.

A particular version of the terminal neuron is shown in FIG. 8. As already indicated, the terminal neuron in the proposed use of a neurosemantic network to process events has one input k=1. And the value of this input v_in[0] is the value of the event field. Attribute c is equal to the channel number corresponding to the field of this value. The duration of the time of the field value is zero: v_d[0]=0. And the terminal length is unit (one value) l=1.

Another particular version of the neuron in FIG. 8 is presented for an event neuron on layer 1. The number of inputs k of such a neuron is at least one and the maximum is equal to the number of fields defined in the configuration of the system 300. All values of the event fields occur simultaneously, so the vector v_d contains k zeros and the total duration of the event is also zero d=0. The terminal length of the event is equal to the number of field values, i.e., l=k.

Another particular version of the neuron in FIG. 8 is presented for the top neuron of the episode. In this case, k is equal to the number of events in the episode. The inputs of the v_in neuron indicate the neurons of the episode event in the order in which they occurred in the episode. It should be noted that if the same event enters the episode several times, then the corresponding elements of v_in indicate the same neuron event. The vector v_d contains the exact time intervals between events. The first interval v_d[0], corresponding to the first event in an episode, is zero, because at the level of the episode neuron, it is not known what happened before the first event of the episode. For the top neuron of the episode, the feature e=0 is created. Also, as mentioned above, for each episode this part of the neurosemantic network grows linearly over time, but is actually a time-ordered set of links (inputs) to the neurons of events, allowing the history of events to be fully reconstructed.

Another particular variant of the neuron in FIG. 8 is presented for a pattern neuron on layer 2 or higher. The v_in input vector indicates events or neurons of patterns of the previous layer of the neurosemantic network. The vector v_d corresponds to the intervals of activation of inputs at the time the neuron of the pattern is created. The number of inputs of the regular pattern k is, for example, in the interval [2, 8] (hyperparameters of the neurosemantic network layer). For a top pattern, the number of inputs k can be above the upper bound. Unlike the top neuron of an episode, where all intervals between events are exactly stored in the vector v_d, for a neuron of the pattern vector v_d contains the intervals between inputs as they were when the neuron was created. If a sequence of events with an order of events similar to the one that was when the neuron was created but a sequence duration that does not coincide with that of neuron d is encountered in the event stream, the pattern neuron can still be mapped to that sequence (i.e., activated) if the sequence duration is within some valid interval specified, for example, how_d·[max(0,1−σ), 1+σ], where σ>0 is a hyperparameter of the neurosemantic network.

Thus, the episode is sequentially processed on the layers of the neurosemantic network: by matching the values of the event fields of terminal neurons, by matching the events of the neurons of the first layer, by creating neurons of top-episodes on the second layer, by matching the sequences of events of the neurons of the patterns on the second and higher layers up to the layer on which one neuron of the top-pattern will be mapped or the maximum layer will be reached.

In one aspect, neuron mapping during processing is performed by activating a neuron of the corresponding layer if it is found (recognized), or by creating and activating a new neuron if a new field value, event or pattern is observed, depending on the layer.

The above method of creating neurons allows one to partially stop learning the neurosemantic network by forcing a transfer to a mode where the creation of new neurons does not occur, and all network training occurs only by changing the neurons when they are activated (the attribute of the neuron w, which is responsible for the number of activations, changes).

In another aspect, this method of processing episodes allows one to train the neurosemantic network by “supervised learning (training with the teacher)” due to the special submission of target (presented by the teacher) patterns to the input and the subsequent modification of the w attribute formed for these patterns of neurons, assigning it a sufficiently large value. This allows increasing the priority of this neuron when it is recognized on the stream compared to other neurons corresponding to other patterns (see the explanation above about the sorting of neurons when covering the episode), thus the recognition of the pattern presented by the teacher is guaranteed.

FIG. 9a illustrates an exemplary of a treatment of an episode by a neurosemantic network for a case where the direction of attention is not determined in accordance with aspects of the present disclosure. Thus, FIG. 9A shows an example of how to handle an episode. In this example, no direction of attention is defined, and patterns are constructed from all events. The diagram shows that the sequence of two events E1-E2 occurs twice, but at different time intervals. However, for the hyperparameter value used in the example, σ=0.5 duration of the second pair of events E1-E2 is within the interval and the same pattern P2_1 is activated on both pairs [σ/2, 3σ/2].

FIG. 9b illustrates an exemplary method for processing episodes for a case where one direction of attention is defined in accordance with aspects of the present disclosure. Thus, FIG. 9b shows an example of episode processing modified from FIG. 9A: one direction of attention being defined to correspond to the value “ul” of the “user” field. Accordingly, the event processor filtered only events with a value of the “user” field equal to “ul” from the full input sequence to search for patterns, and created on layer 3 the top pattern P3_1, which has two inputs, each pointing to the same pattern P2_1 of layer 2.

FIG. 10 illustrates an exemplary method for processing intervals between the inputs of neurons of an episode, including cases of “transitional” neurons with one input, on layers of the neurosemantic network in accordance with aspects of the present disclosure. Events correspond to neurons of layer 1, which are conventionally indicated by one letter: a, b, c, d, e, f—and are located on the time axis in the order and at intervals as they occur within the episode. In this example, the method tracks patterns among all the events of the episode (similar to FIG. 9A). The hyperparameter is selected as: σ=0.5. The sequence of events ab occurs three times, corresponding to the pattern p1 on the second layer. The sequence of events cde occurs twice, corresponding to the pattern p2 on the second layer of the network. Event f occurs once in the episode, and on the second layer it corresponds to the “transitional” pattern p3 with zero duration is like the event itself. On the third layer of the network, the sequence of patterns p1p2, which occurs twice on the second layer, corresponds to pattern n1. But pattern p3 and pattern p1, which begins at time t5, are transmitted to the third layer through “transitional” neurons with one input—respectively n3 with a duration of 0 and n2 with a duration equal to t6-t5.

As part of episode event processing, the intervals between patterns correspond to the exact intervals between events corresponding to the beginning and end of those patterns. For example, in FIG. 10, the interval on layer 2 between the first pattern p2 and the second (mean) pattern p1 is exactly equal to the interval t5-t4. But the durations of the patterns themselves are only approximately equal to the duration between the events corresponding to the beginning and end of the pattern, as explained in FIG. 9a. For example, in FIG. 10 the duration between events c and e in the first cde sequence is t3-t1, while the duration between events c and e of the second cde sequence is t11-t9, which is greater than t3-t1. The pattern p2 for t3-t1 of the interval and the pattern p2 for the t11-t9 of the interval are used the same way, but in FIG. 10, both times, the pattern is depicted using rectangles of different widths, and when processing one episode to the next, the third layer transmits precise intervals as its duration—respectively t3-t1 and t11-t9.

The above description of the intervals is true only at the stage of processing the events of the episode. After the episode events are processed, accurate information about the intervals between events in the patterns is not stored. If, after the end of episode processing, the top pattern of the top1 episode to the event layer is expanded, the information about the intervals between events will be restored only with a certain accuracy. For example, with such an expanding, top1 on the second layer will expand into two patterns p1 the same length—the length that corresponds to the moment of creation of the neuron of this pattern, i.e., t3-t1 in this example.

This feature of working with the duration of pattern neurons allows the user to summarize the information in the input stream to the level of the order of events while maintaining the intervals between events only with a certain accuracy. Such a generalization is able to reflect real processes in the objects of the CPS or IS, in which the times within the same order sequences of events can vary.

Accurate information about all the times of events in all episodes is stored after processing episodes only in the neurons of top-episodes on the second layer of the network (see e.g., FIG. 9A).

FIG. 11 illustrates an exemplary implementation of a neurosemantic network activity monitoring due to special neuronal monitors 302d on the minus first layer (−1) of this network in accordance with aspects of the present disclosure. In a particular aspect of this example, the neuron-monitor 302d named “Monitor 1” has one input with a dendritic tree. For each node of the dendritic tree, logic is determined when creating a monitor neuron (in particular, a logical “and” or a logical “or”), and the dendritic tree as a whole determines how the neuron-monitor can be activated. These nodes can be attached to the root (root node) of the dendritic tree. Dendritic node logic is applied to event field values (see e.g., FIG. 6). The number of inputs in the nodes of the dendritic tree can change during the operation of the network—for example, a monitor neuron may subscribe to new neurons created in the network that satisfy some of the conditions imposed on the values of the event fields corresponding to these neurons—thereby changing the number of inputs in the nodes of the dendritic tree.

In the present example, the monitor neuron 302d “Monitor 1” is activated by one event neuron e1 on layer 1 or (node “or”)) creating new neurons of events on layer 1 and at the same time (node “and”) having input from neuron-value v1 on layer 0 in channel 0. If the second condition for a new event with a given field value is met, then, Monitor 1 is activated and at the same time remembers the newly created event already as a new input in the “or” node from the created event neuron.

Addressing neurons in the “or” node allows a user to automatically receive alerts only from those neurons of the neurosemantic network that fall within the subscription area, significantly reducing the load on the use of computing resources of the technical solution. This approach is in contrast to the option of receiving alerts about the creation or activation of any neuron of the network and subsequently checking whether this neuron corresponds to the subscription filters of the monitor neuron 302d.

However, in the case of subscribing to a layer, the subscriber receives information about the creation of all the neurons in this layer and only then filters out those neurons that meet additional conditions for the values of the fields in the “and” node.

In one aspect, during its operation, the monitor neuron 302d counts the number of its activations on a sliding window. Notification of the user by the monitor neuron 302d is made when a predetermined threshold for the number of activations of the monitor neuron 302d on the sliding window is exceeded.

In one aspect, when using the “attention” option for the field of the monitor neuron 302d, it is possible to multiple subscribe to each individual attention direction value for a given field: for each value of this field, a child, hidden from the user, individual monitor neuron 302d of the number of activations for this individual value is created. Information about the activation of the child neuron-monitor 302d may be created and may be passed on to the parent. Hiding child monitors from the user is appropriate, because in practical cases, the number of field values can be very large and the user interface 303 would be greatly overloaded without such a concealment. At the same time, transmitting information about the activation of the daughter monitor neuron 302d to the parent monitor neuron 302d solves the task of alerting the user (or an external CPS system or IS).

Thus, the method of the present disclosure solves technical problems in identifying, in the flow of events from the CPS or IS, a structure of hierarchically nested repetitive (but not necessarily periodic) patterns, which reflects cause-and-effect relationships in the flow of events from the CPS or IS, as well as in assigning new patterns and new events to anomalies. Moreover, information about which event or pattern or what part of the pattern structure has not previously been observed indicates the presence of an anomaly in the CPS or IS.

In another aspect, the method of the present disclosure makes it possible to identify repetitive events and patterns and their structure, as well as to attribute new events and new patterns to anomalies in operations of the CPS or IS in the flow of events from the CPS or IS. The identification of repetitive events is performed via machine learning methods based on a neurosemantic network without the need to divide the work process into two isolated phases: a) training on historical data and b) recognition.

In another aspect, the method of the present disclosure improves the quality of detection of events and patterns and their attribution to an anomaly in the work of the CPS or IS due to each of the following factors: continuous training, additional optimization of the neurosemantic network during a special phase of the cycle of operation in the “sleep” mode (see FIG. 4) of the system, a mechanism for selective monitoring of the activity of a neurosemantic network based on special monitor neurons, interaction with predictive detectors that detect anomalies in telemetry.

In another aspect, the method of the present disclosure also makes it possible to detect patterns and anomalies in both CPS or IS if there are only a small number of examples of sequences of events corresponding to the pattern in the data, through the use of a neurosemantic network.

In another aspect, the method of the present disclosure also reduces the level of information noise in the flow of events by using a mechanism of attention to the values of event fields characterizing a particular CPS or IS.

FIG. 12 is a block diagram illustrating a computer system 20 on which aspects of systems and methods for identifying the structure of patterns and anomalies in the flow of events coming from the cyber-physical system or information system may be implemented in accordance with exemplary aspects. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 12, above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for detecting patterns and anomalies in the flow of events coming from a cyber physical system (CPS) or an information system (IS), the method comprising:
using at least one connector, getting event data that includes a set of field values and an event timestamp for each event, generating at least one episode consisting of a sequence of events, and transferring the generated episodes to an event processor; and
using the event processor, process episodes using a neurosemantic network,
wherein the processing episodes includes recognizing events and patterns previously learned by the neurosemantic network, training the neurosemantic network, identifying a structure of patterns by mapping to the patterns of neurons on a hierarchy of layers of the neurosemantic network, attributing events and patterns corresponding to neurons of the neurosemantic network to an anomaly depending on a number of activations of the corresponding neuron, and storing the state of the neurosemantic network.

2. The method according to claim 1, wherein the processing of the episode further comprises:
identifying a set of events and patterns of the neurosemantic that satisfy a predetermined criterion; and
generating output information about the set of events and patterns through the use of special neuron-monitor neurons of the neurosemantic network, which, by activating monitor neurons, monitor the creation and activation of the neurons corresponding to events and patterns,
wherein the predetermined criteria specify at least: values of the fields of individual events and events in the patterns; a sign of an recurrence of the events and patterns; and tracking, based on a sliding time interval, the activations and the number of activations during the sliding time interval.

3. The method of claim 1, wherein the training is partially stopped by forcing the transfer of the neurosemantic network to a mode where the creation of new neurons does not occur, and wherein all training occurs only by changing neurons when they are activated.

4. The method of claim 1, wherein a teacher is used for training a neurosemantic network by submitting, to the input, targeted patterns for training, and wherein a frequency of activation and/or a number of activations are based only on subsequent modification of the attribute in the generated neurons.

5. The method of claim 1, wherein patterns are periodically removed from the neurosemantic network of unused neurons, wherein the use of neurons is determined by statistical properties of neurons and a hierarchical principle of a minimum length of description, the minimum length determining a functioning of the neurosemantic network.

6. The method of claim 1, wherein the structure of patterns is revealed through a hierarchy of layers of the neurosemantic network, the structure determining the order of the layers of the neurosemantic network on which neurons are located, and wherein the processing of events using the neurosemantic network comprising:
on the zero layer of the neurosemantic network, having neurons corresponding to the values of the event fields, grouped by channels corresponding to the event fields, wherein the duration of the terminal neuron being taken as being zero and the zero layer being a terminal layer;
on the first layer of the neurosemantic network, having neurons corresponding to events, and having inputs from neurons of the terminal layer, wherein each input corresponds to the terminal neuron of the channel, different from the channels of terminal neurons of other inputs, the time intervals between event inputs from the field values being taken as being equal to zero, and a total duration of the event neuron being respectively taken as being equal to zero thereby indicating that the event has no duration;
on the second layer of the neurosemantic network, having neurons corresponding to episodes, the number of inputs of the neuron of the episode being equal to the number of events in the episode, the intervals between events in the episode being exactly stored as intervals between inputs of the neuron of the episode; and
the second and subsequent layers of the neurosemantic network having neurons corresponding to the sequences of events, with neurons of the third layer and subsequent layers having inputs from neurons of the previous layers and an expanding of the pattern to a sequence of events being carried out through recursive disclosure of all inputs up to the first layer, and the event being expanded to the values of the fields through inputs from terminal neurons.

7. The method of claim 6, wherein each episode is sequentially processed on the layers of the neurosemantic network:
by matching the values of the event fields of the terminal neurons,
by matching the events of the neurons of the first layer,
by creating neurons of the top episodes on the second layer,
by matching the sequences of events of the neurons of the patterns on the second and above layers up to the layer on which one neuron top neuron is mapped indicating the pattern reaching the maximum layer.

8. The method of claim 6, wherein the activation of the pattern neuron is performed when recognizing a sequence in the event stream, with an event order corresponding an order of events obtained by opening the neuron performed recursively through inputs up to the first layer, and the duration of the detected sequence being within the interval determined by a duration of the neuron of the pattern and a neurosemantic network hyperparameter being greater that zero in accordance to d·[max(0, 1−σ), 1+σ]d, when (σ>0).

9. The method of claim 6, wherein neurons-monitors are created or changed by the user during the operation of the neurosemantic network on a special minus first layer, allowing to monitor the creation and activation of neurons of the neurosemantic network under specified conditions, and wherein the monitor neurons are used as output channels from the neurosemantic network to alert a user or an external system.

10. The method of claim 6, wherein the neurons of the zero layer and subsequent layers have at least the following properties:
contain a vector of input connections from the neurons of the previous layer; for the zero layer, the vector contains a single categorical or converted to a categorical value of the event field;
contain a vector of time intervals between activations of connections from neurons of the previous layer fixed when the neuron was created, for the zero layer, the vector consisting of one zero value, for neurons of the first layer and subsequent layers having only one input, the duration of the single input being equal to the duration of the single input neuron;
if there are output connections, contain the set of the output connections to the monitor neurons being minus the first layer;
contain the time of the last activation of the neuron; and
contain a statistical parameter that reflects the frequency of activations of the neuron, in particular the number of activations.

11. The method of claim 6, wherein the attention configuration of the neurosemantic network is further specified by specifying attention directions for filtering the received events based on criteria for field values for recognizing patterns among events filtered in each such direction.

12. The method of claim 11, wherein each episode is sequentially processed on layers from the second and above layers for each direction of attention in the case of setting the attention configuration, up to the layer on which a top pattern is mapped for this direction of attention or a maximum layer is reached.

13. The method of claim 11, wherein a neuron is mapped during processing by activating a neuron of a corresponding layer if it is recognized, or by creating and activating a new neuron if a new field value, event, or pattern is observed, depending on the layer.

14. The method of claim 11, in which the hierarchical structure of patterns on the layers of the neurosemantic network is optimized by periodically switching the neurosemantic network to a sleep mode, wherein the events in the episodes are not processed or are processed in parallel on other computing resources, in the sleep mode, events are processed from the event history interval obtained by combining several short episodes and ordering events according to their time, for cases where some of the events in the stream came outside of their episode, and processing at long intervals for those areas of attention for which events are rare, or in the case of a change in the direction of attention.

15. The method of claim 11, wherein the neurons have at least the following properties:
contain at least one input to which a dendritic tree is attached with nodes implementing logical operations on the outputs attached to them from other neurons or from network layers;
contain a dendritic node attached to the root of the dendritic tree with a logical operation “or” and outputs attached to the node from neurons of the zero and subsequent layers used to detect the activation of field values, events and patterns already learned by the network, the criterion for the subscription of the monitor neuron to the activation of such neurons being set through the definition of conditions for field values;
contain 0 or more attached to the node “or” other dendritic nodes with a logical operation “and”, to which in turn are attached outputs from neurons of the zero layer corresponding to the values of the fields and outputs directly from the zero layer and subsequent layers, which are used to detect the creation of new neurons corresponding, depending on the layer, to the values of the fields, either events or patterns, dendritic nodes “and” set the conditions for what field values the neurons created on the specified layers must have in order to activate this neuron-monitor;
have the ability to dynamically change the set of inputs of the monitor neuron from the network neurons to automatically add to the dendritic node “or” new created neurons that meet the criteria of the dendritic node “and”;
have the ability to set an attention option on the values of the subscription fields and create child monitor neurons for each unique value or a unique combination of such values of such fields, becoming the parent monitor neuron, child monitor neurons will count the number of activations with this unique value and the rest of the subscription conditions, as in the parent monitor neuron, and notify the parent monitor about their trigger;
have the ability to subscribe only to previously created and activated more than once neurons, and only to new neurons that are activated once, as well as to both together, subscribing only to new neurons being considered as anomalies in the flow of events; and
contain a property for specifying the sliding monitoring interval and the amount of activation of the monitor neuron at the sliding interval, upon reaching which the monitor neuron will generate an alert to the user or other systems.

16. The method of claim 1, wherein the sequence of events are obtained either before a fulfillment of one of the conditions, the conditions including a time limit has been reached or a limit on the number of events has been reached, or before the fulfillment of the one of the said conditions that was fulfilled first.

17. The method of claim 1, wherein the recognizing events and patterns previously learned by the neurosemantic network includes recognizing sequences of events in which the order of events is observed, and wherein the time intervals between events are within the specified constraints stored in the form of neurons of the neurosemantic network, and wherein the activation of the neurons is recognized.

18. The method of claim 1, wherein the training of the neurosemantic network, consists in the creation and activation of neurons that are mapped to new values of event fields, new events, and new patterns, and activation of recognized previously learned neurons in such a way that previously learned and new patterns of the neurosemantic network cover all the events of the episode.

19. The method of claim 1, the preserving the state of the neurosemantic network includes preserving information about created and activated neurons in a storage subsystem.

20. A non-transitory computer readable medium storing thereon computer executable instructions for detecting patterns and anomalies in the flow of events coming from a cyber physical system (CPS) or an information system (IS), including instructions for:
using at least one connector, getting event data that includes a set of field values and an event timestamp for each event, generating at least one episode consisting of a sequence of events, and transferring the generated episodes to an event processor; and
using the event processor, process episodes using a neurosemantic network,
wherein the processing episodes includes recognizing events and patterns previously learned by the neurosemantic network, training the neurosemantic network, identifying a structure of patterns by mapping to the patterns of neurons on a hierarchy of layers of the neurosemantic network, attributing events and patterns corresponding to neurons of the neurosemantic network to an anomaly depending on a number of activations of the corresponding neuron, and storing the state of the neurosemantic network.
